(19) United States
(12) Patent Application Publication
(10) Pub. No.: US 2013/0236095 A1
(43) Pub. Date: Sep. 12, 2013

(54) IMAGE PROCESSING DEVICE, IMAGE PROCESSING METHOD, AND PROGRAM

(71) Applicant: SONY CORPORATION, Tokyo (JP)

(72) Inventors: Yasunobu Hitomi, Kanagawa (JP); Tomoo Mitsunaga, Kanagawa (JP)

(73) Assignee: Sony Corporation, Tokyo (JP)

(21) Appl. No.: 13/778,891

(22) Filed: Feb. 27, 2013

(30) Foreign Application Priority Data
Mar. 8, 2012 (JP) 2012-051297
Jun. 28, 2012 (JP) 2012-145055

(51) Int. Cl. G06T 5/00

(52) U.S. Cl. CPC G06T 5/002
USPC 382/167

(57) ABSTRACT

There is provided an image processing device including: an image analysis unit and a pixel value correction unit, wherein the image analysis unit sets a plurality of bins having different bin widths which are set by a luminance range varying in size depending on a luminance value, and generates frequency distribution data obtained by setting the number of pixels contained in a luminance range corresponding to each bin as frequency data, and wherein the pixel value correction unit selects a bin corresponding to a pixel to be corrected which is a bin including the pixel value of the pixel to be subjected to noise reduction and a predetermined number of neighboring bins, and calculates a corrected pixel value of the pixel to be subjected to noise reduction by an arithmetic operation process to which a pixel value of a reference pixel contained in the selected bin is applied.

### BACKGROUND

The present disclosure relates to image processing devices, image processing methods, and programs. More particularly, the present disclosure relates to an image processing device, image processing method, and program capable of reducing image noise.

When a noise reduction (NR) process of reducing noise in an image is performed, for example, a process to which a plurality of images captured by continuous shooting including the same subject is applied is performed. In this regard, image processing technologies for noise reduction using a plurality of images are disclosed in the related art documents, such as Japanese Patent Application Laid-Open Publication Nos. 2009-194700 and 2009-290827.

In these documents, there is disclosed a process which performs noise reduction by using a plurality of images captured by continuous shooting, by setting a reference region located around a pixel to be subjected to noise reduction (target pixel) in each of the images, and by calculating a corrected pixel value of the pixel to be subjected to noise reduction (target pixel). The calculation of corrected pixel value is made by performing an arithmetic mean operation or the like on pixel values of pixels contained in the reference region.

When the noise reduction process is performed, it has been known that more images make it possible to implement an effective noise reduction.

Further, in a three-dimensional noise reduction (NR) algorithm which performs an arithmetic mean operation on temporally successive aligned images, it has been known that the widening of a reference range is effective to increase NR effect.

However, the widening of the reference range results in increasing the number of pixels contained in the reference range. In addition, a pixel having a pixel value significantly different from a pixel value of a target pixel to be subjected to noise reduction may be contained in the reference range. This is caused by, for example, the presence of a moving subject, the presence of an error pixel, an unexpected change in the image capturing environments, and so on. Because of these various factors, a pixel having a pixel value significantly different from that of the target pixel may be found in the reference region.

As described above, if a pixel value significantly different from a pixel value of a target pixel to be subjected to noise reduction is applied to a process of calculating a corrected pixel value of the target pixel, such as an arithmetic mean process, then the corrected pixel value of the target pixel will be set to an erroneous value.

Thus, when a pixel having a pixel value significantly different from a pixel value of the target pixel to be subjected to noise reduction process is contained in the reference region, the pixel is required to be not included in a process of calculating a corrected pixel value.

In this way, a corrected pixel value is calculated by excluding a pixel in the reference region having pixel value significantly different from a pixel value of a pixel to be corrected and by performing an arithmetic mean operation or the like on only the selected reference pixel, thereby being capable of achieving a more accurate noise reduction.

In a case where the process described above is performed, it is required for the determination process of whether or not an arithmetic mean process can be applied for each of the pixels contained in a reference region which is set in a neighboring region of the target pixel to be subjected to noise reduction process.

This determination process is carried out, for example, by comparing the difference between the luminance value of a target pixel and the luminance value of each pixel in a reference region with a predetermined threshold. The target pixel is a pixel to be subjected to arithmetic mean process only if the difference between the luminance value of a target pixel and the luminance value of each pixel in a reference region is less than the threshold.

However, in the case where the determination process described above is performed, there is a need to compare every pixel contained in a reference region with the threshold. Thus, when the number of pixels contained in the reference region is large, a problem of increasing computational cost occurs.

### SUMMARY

Embodiments of the present disclosure are made in consideration of the above-mentioned problems, and are intended to provide an image processing device, image processing method, and program capable of effectively reducing image noise.

According to a first embodiment of the present disclosure, there is provided an image processing device including an image analysis unit for generating image analysis information having frequency distribution data which corresponds to a pixel value of a pixel contained in a reference region used to select a reference pixel applied to correction of a pixel value of a pixel to be subjected to noise reduction, and a pixel value correction unit for correcting a pixel value by applying the image analysis information. The image analysis unit sets a plurality of bins having different bin widths which are set by a luminance range varying in size depending on a luminance value, and generates frequency distribution data obtained by setting the number of pixels contained in a luminance range corresponding to each bin as frequency data. And the pixel value correction unit selects a bin corresponding to a pixel to be corrected which is a bin including the pixel value of the pixel to be subjected to noise reduction and a predetermined number of neighboring bins of the bin corresponding to the pixel to be corrected, and calculates a corrected pixel value of the pixel to be subjected to noise reduction by an arithmetic operation process to which a pixel value of a reference pixel contained in the selected bin is applied.

Further, according to an embodiment of the present disclosure, the pixel value correction unit may calculate the corrected pixel value of the pixel to be subjected to noise reduction by performing an arithmetic mean process on the pixel value of the reference pixel contained in the selected bin.

Further, according to an embodiment of the present disclosure, the image analysis unit may generate frequency distribution data obtained by setting a value of noise standard deviation σ(Y) corresponding to a luminance value Y or a value kσ(Y) as the bin width by using data indicating a corresponding relationship between the luminance value and the noise standard deviation, the value kσ(Y) being obtained by multiplying the noise standard deviation σ(Y) by a predetermined factor k.

Further, according to an embodiment of the present disclosure, the image analysis unit may generate sum data obtained by adding a pixel value of a pixel corresponding to each bin as supplemental data in conjunction with the frequency distribution data which is set by the plurality of bins having different bin widths.

Further, according to an embodiment of the present disclosure, the image analysis unit may generate sum data obtained by adding each of respective pixel values Y, U, and V of a pixel corresponding to each bin as the supplemental data.

Further, according to an embodiment of the present disclosure, the pixel value correction unit may reselect a bin in which a difference between the pixel value of the pixel to be subjected to noise reduction and respective average values of U and V of the selected bin calculated from sum data obtained by adding each of respective pixel values U and V which are the supplemental data of the selected bin is determined to be less than a predetermined threshold, and calculates the corrected pixel value of the pixel to be subjected to noise reduction by performing an arithmetic operation process to which a pixel value of a reference pixel contained in the reselected bin is applied.

Further, according to an embodiment of the present disclosure, the pixel value correction unit may reselect a bin in which a difference between respective average values of U and V of a central bin including the pixel to be subjected to noise reduction and respective average values of U and V of the selected bin is determined to be less than a predetermined threshold, and calculates the corrected pixel value of the pixel to be subjected to noise reduction by performing an arithmetic operation process to which a pixel value of a reference pixel contained in the reselected bin is applied.

Further, according to an embodiment of the present disclosure, the image processing device may further include an image size reduction unit for reducing a size of an image including the pixel to be subjected to noise reduction. The image analysis unit may generate the image analysis information based on a reduced-size image generated by the image size reduction unit.

Further, according to an embodiment of the present disclosure, the image size reduction unit may generate the reduced-size image by performing an edge-preserving smoothing process.

Further, according to an embodiment of the present disclosure, the image analysis unit may set a pixel region corresponding to a plurality of images captured by continuous shooting as a reference region and generate image analysis information having frequency distribution data corresponding to a pixel value of a pixel contained in the reference region, the plurality of images being constituted by an image which contains the pixel to be subjected to noise reduction.

Further, according to an embodiment of the present disclosure, the image analysis unit may generate the frequency distribution data for each image, stores the generated frequency distribution data for each image in a FIFO buffer, and generate image analysis information having frequency distribution data which corresponds to a pixel value of a pixel contained in a reference region set in a plurality of images captured by continuous shooting by performing an arithmetic operation process on the frequency distribution data of the plurality of images stored in the FIFO buffer.

Further, according to a second embodiment of the present disclosure, there is provided an image processing method of performing a noise reduction process on a pixel in an image processing device, the image processing method including generating, by an image analysis unit, image analysis information having frequency distribution data which corresponds to a pixel value of a pixel contained in a reference region used to select a reference pixel applied to correction of a pixel value of a pixel to be subjected to noise reduction, and correcting, by a pixel value correction unit, a pixel value by applying the image analysis information. The image analysis step is a step of setting a plurality of bins having different bin widths which are set by a luminance range varying in size depending on a luminance value, and generating frequency distribution data obtained by setting the number of pixels contained in a luminance range corresponding to each bin as frequency data. And the pixel value correction step is a step of selecting a bin corresponding to a pixel to be corrected which is a bin including the pixel value of the pixel to be subjected to noise reduction and a predetermined number of neighboring bins of the bin corresponding to the pixel to be corrected, and calculating a corrected pixel value of the pixel to be subjected to noise reduction by an arithmetic operation process to which a pixel value of a reference pixel contained in the selected bin is applied.

Further, according to a third embodiment of the present disclosure, there is provided a program for causing an image processing device to perform a noise reduction process on a pixel, the process including generating, by an image analysis unit, image analysis information having frequency distribution data which corresponds to a pixel value of a pixel contained in a reference region used to select a reference pixel applied to correction of a pixel value of a pixel to be subjected to noise reduction, and correcting, by a pixel value correction unit, a pixel value by applying the image analysis information. The image analysis step is a step of setting a plurality of bins having different bin widths which are set by a luminance range varying in size depending on a luminance value, and generating frequency distribution data obtained by setting the number of pixels contained in a luminance range corresponding to each bin as frequency data. And the pixel value correction step is a step of selecting a bin corresponding to a pixel to be corrected which is a bin including the pixel value of the pixel to be subjected to noise reduction and a predetermined number of neighboring bins of the bin corresponding to the pixel to be corrected, and calculating a corrected pixel value of the pixel to be subjected to noise reduction by an arithmetic operation process to which a pixel value of a reference pixel contained in the selected bin is applied.

In addition, the program according to an embodiment of the present disclosure is, for example, a program that can be provided by a storage medium or a communication medium in a computer-readable format to an information processing device or a computer system that can execute various types of program code. By providing such a program in the computer-readable format, a process corresponding to the program can be executed on the information processing device or the computer system.

Further objects, features, and advantages of the present disclosure will become apparent from the following detailed description, taken in conjunction with embodiments of the present disclosure and the accompanying drawings. In this specification, the system is a logical structure configured to include a plurality of devices, and not all devices of the structure are necessary to be arranged in a single housing.

In accordance with an embodiment of the present disclosure, there is provided a device and method capable of performing an effective noise reduction process on an image.

Specifically, an embodiment of the present disclosure includes an image analysis unit for generating image analysis information having frequency distribution data which corresponds to a pixel value of a pixel contained in a reference region used to select a reference pixel applied to correction of a pixel value of a pixel to be subjected to noise reduction; and a pixel value correction unit for correcting a pixel value by applying the image analysis information. The image analysis unit sets a plurality of bins having different bin widths which are set by a luminance range varying in size depending on a luminance value, and generates frequency distribution data obtained by setting the number of pixels contained in a luminance range corresponding to each bin as frequency data. The pixel value correction unit selects a bin corresponding to a pixel to be corrected which is a bin including the pixel value of the pixel to be subjected to noise reduction and a predetermined number of neighboring bins of the bin corresponding to the pixel to be corrected, and calculates a corrected pixel value of the pixel to be subjected to noise reduction by an arithmetic operation process to which a pixel value of a reference pixel contained in the selected bin is applied.

These processes make it possible to select promptly only a pixel having a pixel value similar to a pixel value of a pixel to be corrected and implement an effective pixel value correction process, without performing a process of determining whether each pixel is a problematic pixel.

### BRIEF DESCRIPTION OF THE DRAWINGS

FIG. 1 is a diagram for explaining a three-dimensional noise reduction (NR) process;

FIG. 2 is a diagram for explaining a three-dimensional noise reduction (NR) process;

FIG. 3 is a diagram for explaining an overview of the noise reduction (NR) process according to an embodiment of the present disclosure to which variable bin width frequency distribution data (histogram) with supplemental information is applied;

FIG. 4 is a diagram for explaining an exemplary process of excluding a problematic pixel and determining a reference pixel to be selected as a pixel to be subjected to an arithmetic mean process;

FIG. 5 is a diagram for explaining an exemplary configuration of an image processing device according to an embodiment of the present disclosure;

FIG. 6 is a diagram for explaining an exemplary process of the image processing device according to an embodiment of the present disclosure;

FIG. 7 is a diagram for explaining an exemplary configuration and process of an image size reduction unit in the image processing device according to an embodiment of the present disclosure;

FIG. 8 is a diagram for explaining an exemplary configuration and process of the image size reduction unit in the image processing device according to an embodiment of the present disclosure;

FIG. 9 is a diagram for explaining an exemplary configuration and process of an image analysis unit in the image processing device according to an embodiment of the present disclosure;

FIG. 10 is a diagram for explaining an exemplary process performed by the image analysis unit in the image processing device according to an embodiment of the present disclosure;

FIG. 11 is a diagram for explaining an exemplary process performed by the image analysis unit in the image processing device according to an embodiment of the present disclosure;

FIG. 12 is a diagram for explaining an exemplary process performed by a pixel value correction unit in the image processing device according to an embodiment of the present disclosure;

FIG. 13 is a diagram for explaining an exemplary process performed by the pixel value correction unit in the image processing device according to an embodiment of the present disclosure;

FIG. 14 is a diagram for explaining an exemplary process performed by the pixel value correction unit in the image processing device according to an embodiment of the present disclosure;

FIG. 15 is a diagram for explaining an exemplary process performed by the pixel value correction unit in the image processing device according to an embodiment of the present disclosure;

FIG. 16 is a diagram for explaining an exemplary configuration of the image processing device according to an embodiment of the present disclosure;

FIG. 17 a diagram for explaining an exemplary configuration of the image processing device according to an embodiment of the present disclosure; and

FIG. 18 is a diagram for explaining an exemplary hardware configuration of the image processing device according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Overview of process according to embodiment of present disclosure
1-1. General three-dimensional noise reduction (NR) process
1-2. Noise reduction (NR) process according to embodiment of present disclosure using variable bin width frequency distribution data (histogram) with supplemental information

2. Exemplary configuration of image processing device according to embodiment of present disclosure

3. Detailed description of noise reduction process performed by image processing device according to embodiment of present disclosure
3-1. Process performed by image size reduction unit
3-2. Process performed by image analysis unit
3-3. Process performed by pixel value correction unit

4. Modification examples of image processing device according to embodiment of present disclosure
4-1. Modification example of performing repeatedly correction process on generated corrected image by using a feedback
4-2. Modification example of storing histogram in FIFO buffer and sequentially updating the stored histogram for use
4-3. Modification example of adjusting (tuning) a weighting factor and selected threshold of the reference bin applied to the calculation of corrected pixel value

5. Exemplary hardware configuration of image processing device

6. Conclusion

### 1. OVERVIEW OF PROCESS ACCORDING TO EMBODIMENT OF PRESENT DISCLOSURE

Overview of a process performed by an image processing device according to an embodiment of the present disclosure will be described.

[1-1. General Three-Dimensional Noise Reduction (NR) Process]

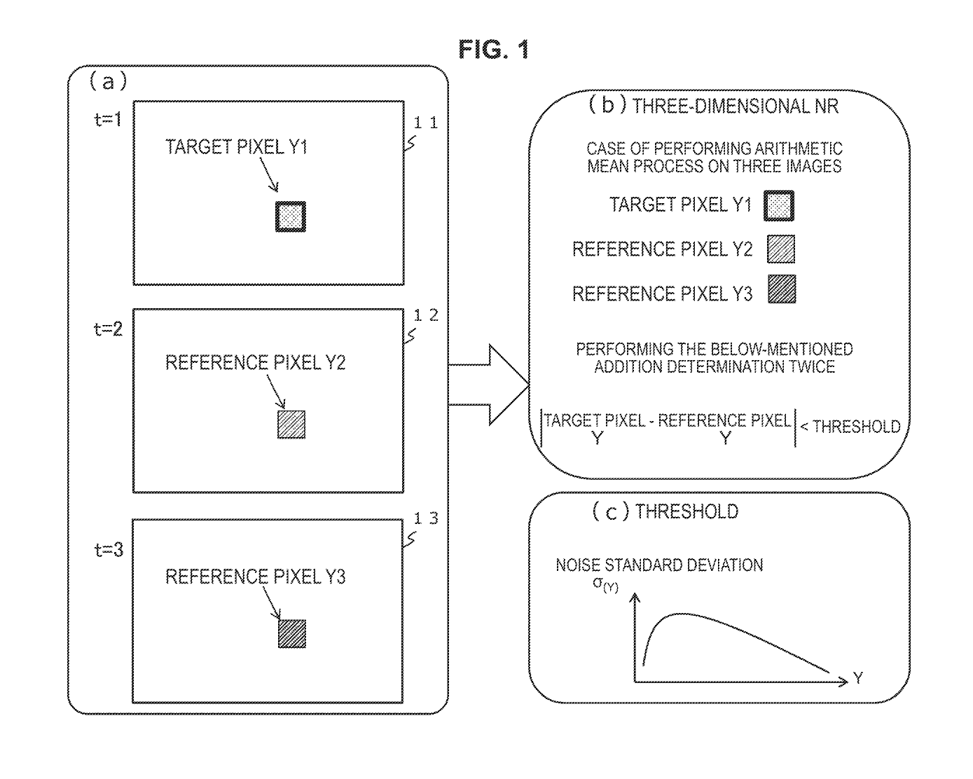

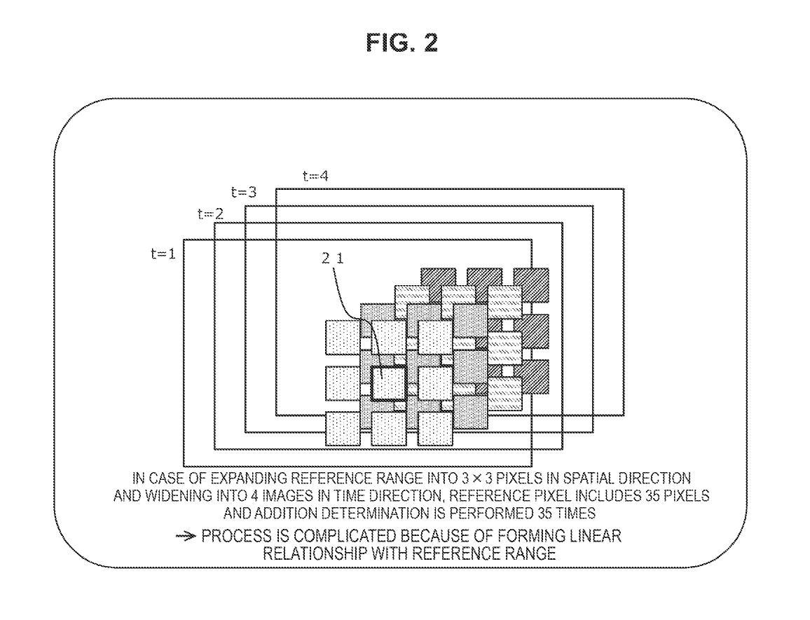

First, a general three-dimensional noise reduction (NR) process will be described with reference to FIGS. 1 and 2.

A three-dimensional noise reduction (NR) process is based on a process performing an arithmetic mean operation on a pixel value of a corresponding pixel position estimated to be a region captured from the same subject by applying a plurality of images captured by continuous shooting.

An example shown in FIG. 1(a) illustrates an example of using the following three images captured by continuous shooting:

Image 11 captured at a time t=1,

Image 12 captured at a time t=2, and

Image 13 captured at a time t=3.

For example, a pixel value has a variety of elements such as RGB or YUV, and a corresponding corrected value is determined for each of these elements.

The example in FIG. 1 shows an exemplary correction process of Y (luminance value). The luminance values are set as follows:

Luminance value=Y1 of a target pixel in the image 11 captured at the time t=1,

Luminance value=Y2 of a reference pixel in the image 12 captured at the time t=2, and

Luminance value=Y3 of a reference pixel in the image 13 captured at the time t=3.

In addition, the target pixels of the images 11 to 13 are set to the same coordinate position of each image.

For example, a reference image is assumed to be the image 11 captured at the time t=1. When the three-dimensional NR process which corrects a pixel value of a target pixel in the image 11 captured at the time t=1, in the present example the luminance value (Y1), is performed, an arithmetic mean operation is calculated for the following three luminance values:

Luminance value=Y1 of a target pixel in the image 11 captured at the time t=1,

Luminance value=Y2 of a reference pixel in the image 12 captured at the time t=2, and

Luminance value=Y3 of a reference pixel in the image 13 captured at the time t=3.

Thus, the result is as follows.

(Y1+Y2+Y3)/3

The value obtained by the arithmetic mean process is set to a corrected pixel value of the target pixel in the image 11. This process becomes a fundamental process.

However, when a corrected pixel value is calculated by the arithmetic mean process, it is necessary to exclude a problematic pixel contained in reference pixels. The term “problematic pixel” means the pixel having a pixel value different from a pixel value of a target pixel, for example, due to the presence of a moving subject, the presence of error pixels, an unexpected change in the image capturing environments, and so on.

In this example, it is necessary to determine whether the following reference pixels are significantly different from a target pixel in terms of pixel value:

Reference pixel of the image 12 captured at the time t=2, and

Reference pixel of the image 13 captured at the time t=3.

More specifically, as shown in FIG. 1(b), the difference between a luminance value Y of the target pixel and a luminance value Y of the reference pixel is compared to a predetermined threshold. When the difference between the luminance value Y of the target pixel and the luminance value Y of the reference pixel is less than the predetermined threshold, it is determined that the pixel is a normal pixel, not a problematic pixel.

On the other hand, when the difference between the luminance value Y of the target pixel and the luminance value Y of the reference pixel is not less than the predetermined threshold, it is determined that the pixel is a problematic pixel.

In addition, for example, the amount of noise estimated according to a luminance value (Y) of a pixel can be applied as the threshold.

In FIG. 1(c), the horizontal axis represents the luminance value (Y), and the vertical axis represents the standard deviation σ(y) of noise estimated to be contained in each pixel according to each luminance value.

There is a general tendency that a small amount of noise is contained in the pixel having a high luminance value but a large amount of noise is contained in the pixel having a low luminance value. Thus, it is known that the corresponding relationship between the luminance value (Y) and the noise standard deviation σ(y) is set as the graph shown in FIG. 1(c).

The standard deviation σ(y) according to the luminance value (Y) or a value kσ(y) obtained by multiplying the standard deviation σ(y) by a factor k (e.g., k=1, k=2) to the standard deviation σ(y) can be used as the threshold. Thus, whether there is a problematic pixel can be determined based on the pixel value (luminance value).

Such a determination process makes it possible to exclude a problematic pixel from among pixels within the reference region and apply only a normal pixel, thereby calculating a corrected pixel value of a target pixel.

For example, there may be a case where a reference pixel in the image 13 captured at the time t=3 is determined to be a problematic pixel and a reference pixel in the image 12 captured at the time t=2 is determined to be a normal pixel. In this case, a pixel value (luminance value Y, in this example) of a target pixel in the image 11 captured at the time t=1 is calculated by the following equation:

Y=(Y1+Y2)/2

The calculation of the corrected pixel value makes it possible to implement the noise reduction with high accuracy by excluding an influence of a moving subject or erroneous pixel.

The example shown in FIG. 1 illustrates the exemplary process which uses only a pixel having one corresponding pixel position from among three images. However, in order to perform more high accuracy correction process (noise reduction process), a process in which a reference region is set to a neighboring region of a pixel to be corrected (target pixel) is performed.

FIG. 2 illustrates an example where a 3×3 pixel region centered on the target pixel 21 captured at the time t=1 is set as a reference region.

The example of FIG. 2 shows an example which uses four images captured by continuous shooting at the times t=1 to t=4.

In the example shown in FIG. 2, the total number of pixels in a reference region set to calculate a corrected pixel value of the target pixel 21 is 36. Specifically, there are 4×9=36 pixels in four images because there are 3×3=9 pixels for each image.

The problematic pixel determination process for determining whether there is a problematic pixel described above referring to FIG. 1 with respect to 35 pixels except for the target pixel from among these 36 pixels is necessary. That is, the process for comparing the difference between a pixel value of the target pixel and a pixel value of the reference pixel with a predetermined threshold is necessary.

In this way, if a reference region is spread in a single image and further expanded in the direction of time axis, then the number of pixels contained in the reference region is increased, and the problematic pixel determination process is to be performed according to the number of pixels, resulting in an increase in computational cost.

[1-2. Noise Reduction (NR) Process According to Embodiment of Present Disclosure Using Variable Bin Width Frequency Distribution Data (Histogram) with Supplemental Information]

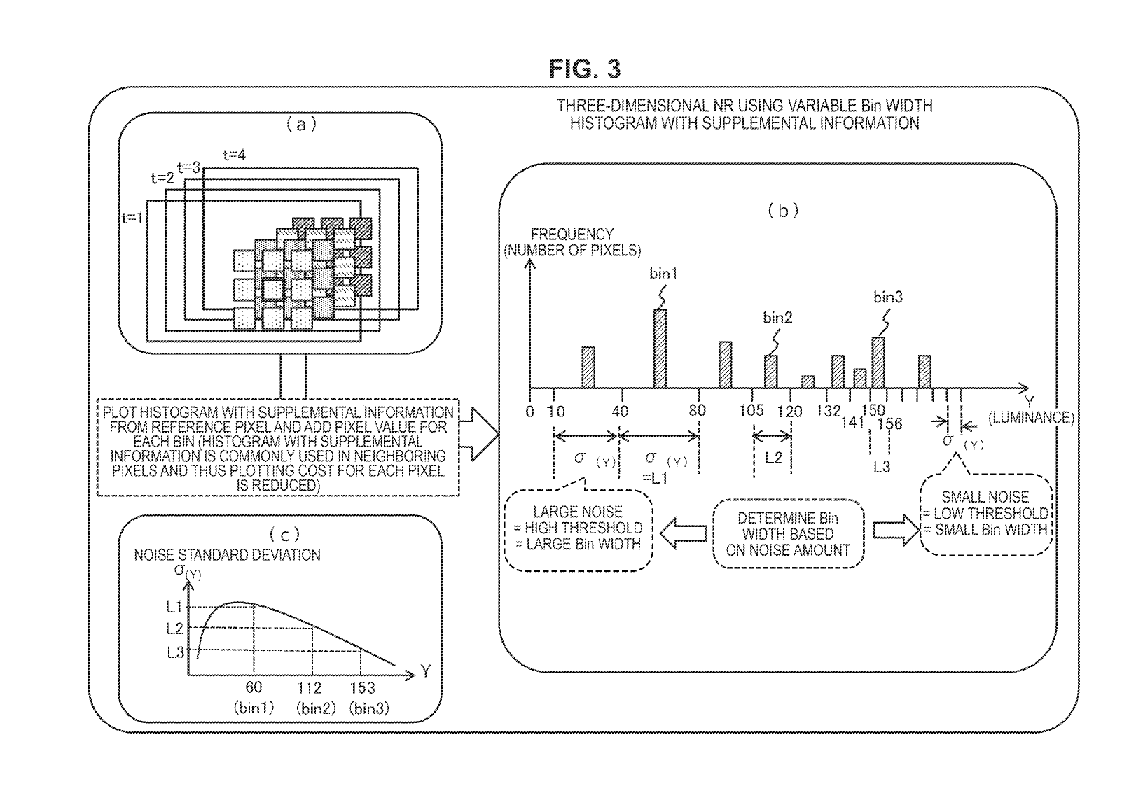

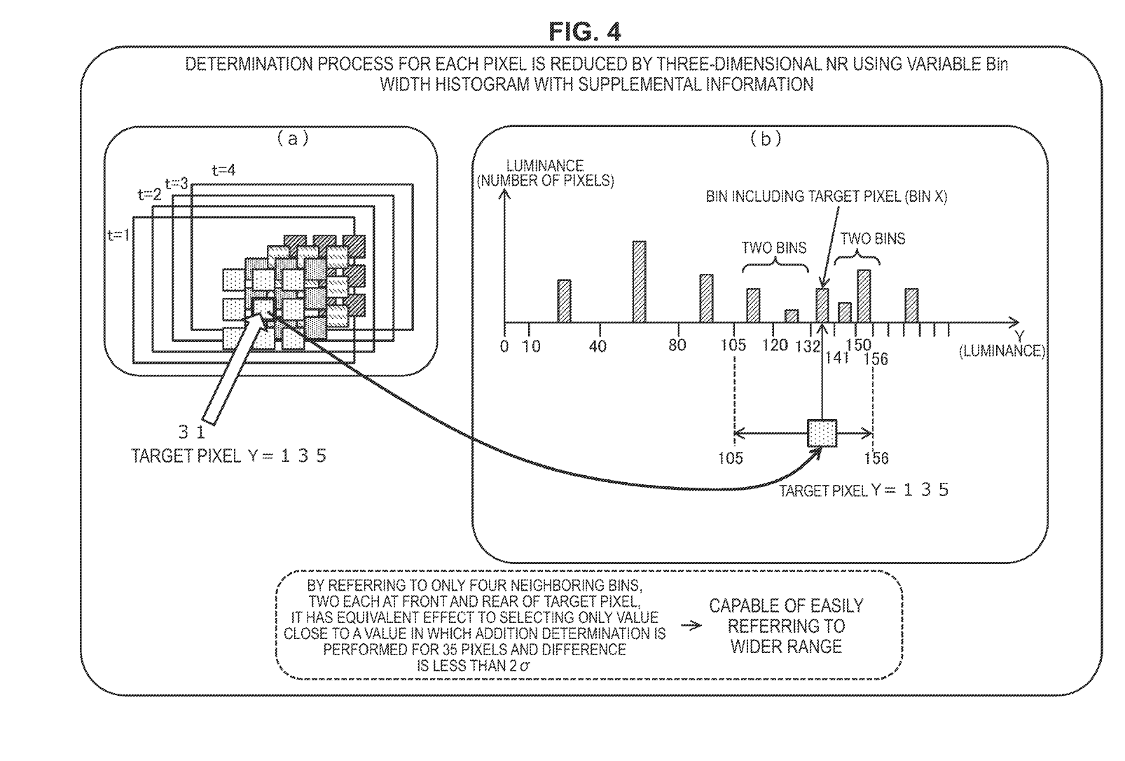

Next, referring to FIGS. 3 and 4, the process according to an embodiment of the present disclosure which solves the above problems, that is, an overview of the noise reduction (NR) process according to an embodiment of the present disclosure using variable bin width frequency distribution data (histogram) with supplemental information will be given.

FIGS. 3 and 4 are diagrams for explaining an overview a noise reduction process performed by an image processing device according to an embodiment of the present disclosure.

FIG. 3(a) illustrates an example of setting a reference region for performing the noise reduction process. In this case, similarly to FIG. 2, the reference region is set to have 3×3=9 pixels in each image and have the same size (3×3 pixels) in each of four images captured at the times t=1 to 4, and thus the number of the reference pixels including a target pixel is 36.

The image processing device according to an embodiment of the present disclosure sets a pixel value of each pixel contained in the reference region, and the pixel value may be a histogram (frequency distribution) of a luminance value (Y).

Further, a bin width of a histogram to be plotted has irregular intervals, but is set based on the amount of noise estimated according to each pixel value (luminance value Y).

Moreover, an average value of a pixel value configuration parameter (e.g., YUV) is calculated in advance for each bin to be set in the histogram when plotting the histogram.

FIG. 3(b) illustrates a histogram of each luminance value (Y) for 36 pixels shown in FIG. 3(a). The horizontal axis represents the luminance value (Y), and the vertical axis represents the frequency, i.e., the number of pixels.

In addition, it should be noted that the setting range, i.e. the luminance range, of each bin is not equal interval (bin corresponds to each bar of a bar chart in the histogram shown in FIG. 3(b)).

For example, a bin (bin1) shown in FIG. 3(b) indicates the number of pixels in a range in which the luminance value (Y) is from 40 to 80, i.e., the luminance range is set to 80−40=40.

However, for example, a bin (bin2) indicates the number of pixels in a range in which the luminance value (Y) is from 105 to 120, i.e., the luminance range is set to 120−105=15.

In addition, a bin (bin3) indicates the number of pixels in a range in which the luminance value (Y) is from 150 to 156, i.e., the luminance range is set to 156−150=6.

In this way, the setting range, i.e. the luminance range, of each bin is set to be non-equidistant. In the following description, the setting range, i.e. the luminance range, of each bin is referred to as a “bin width”.

The bin width is determined based on the amount of noise estimated according to each pixel value (luminance value, in this example).

FIG. 3(c) illustrates a graph similar to that described above referring to FIG. 1(c). Specifically, FIG. 3(c) shows the luminance value (Y) on the horizontal axis and the noise standard deviation σ(y) estimated to be contained in each pixel according to each luminance value on the vertical axis.

There is a general tendency that a small amount of noise is contained in the pixel having a high luminance value but a large amount of noise is contained in the pixel having a low luminance value. Thus, it is known that the corresponding relationship between the luminance value (Y) and the noise standard deviation σ(y) is set as the graph shown in FIG. 3(c).

The bin width of each bin set in the histogram shown in FIG. 3(b) is determined based on noise standard deviation data corresponding to the luminance in FIG. 3(c).

For example, the bin (bin1) shown in FIG. 3(b) indicates the number of pixels in a range in which the luminance value (Y) is from 40 to 80, i.e., a central luminance value≈60. In this case, the bin width is set to a value (L1) of the noise standard deviation σ(y) corresponding to the luminance value≈60 shown in FIG. 3(c), or set to a value kσ(y) (=kL1) obtained by multiplying the value (L1) of noise standard deviation by a factor k. The k is an adjustable parameter, but may be a predetermined fixed value. For example, the k may be configurable by a user.

Similarly, the bin (bin2) shown in FIG. 3(b) indicates the number of pixels in a range in which the luminance value (Y) is from 105 to 120, i.e., a central luminance value≈412. In this case, the bin width is set to a value (L2) of the noise standard deviation σ(y) corresponding to the luminance value≈420 shown in FIG. 3(c), or set to as value kσ(y) (=kL2) obtained by multiplying the value (L2) of noise standard deviation by a factor k.

Likewise, the bin (bin3) shown in FIG. 3(b) indicates the number of pixels in a range in which the luminance value (Y) is from 150 to 156, i.e., a central luminance value≈453. In this case, the bin width is set to a value (L3) of the noise standard deviation σ(y) corresponding to the luminance value≈453 shown in FIG. 3(c), or set to a value kσ(y) (=kL3) obtained by multiplying the value (L3) of noise standard deviation by a factor k.

In this way, the bin width is increased as the value of the noise standard deviation σ(y) becomes large, and the bin width is decreased as the value of the noise standard deviation σ(y) becomes small.

The image processing device according to an embodiment of the present disclosure plots a histogram having such a bin width which is varied according to a pixel value, and determines a reference pixel to be used in calculating a corrected pixel value of a target pixel by applying the plotted histogram. The reference pixel to be used is a reference pixel to be selected as being subjected to arithmetic mean operation by excluding a problematic pixel.

A process of selecting a reference pixel will be described with reference to FIG. 4.

FIG. 4(a) illustrates an example of setting a reference region similar to those of FIG. 3(a) and FIG. 2. A reference region to be set is a 3×3 pixel region set in each of four images captured by continuous shooting.

A pixel to be corrected is set to be a target pixel 31 captured at the time t=1.

A histogram shown in FIG. 4(b) is plotted according to the procedure described above based on 36 pixels contained in a 3×3 pixel region of four images

In this case, a luminance value Y of the target pixel 31 to be subjected to the noise reduction process is set to Y=135.

A bin including the luminance value Y=135 of the target pixel 31 to be subjected to the noise reduction process is first detected in the histogram.

A bin X shown in FIG. 4(b) is the bin including the luminance value Y=135 of the target pixel 31 in the histogram.

The bin X and four neighboring bins, two each at the front and rear of the bin X in the histogram, are selected as bins which contain a reference pixel.

Pixels contained in a total of five bins, including the bin X, two neighboring bins at the low luminance side of the bin X, and two neighboring bins at the high luminance side of the bin X, are selected as reference pixels.

The pixels contained in these bins are set as a group of pixels having a pixel value relatively close to a pixel value (luminance value) of the target pixel 31.

In the example shown in the figure, the pixels contained in these bins are set as a group of pixels contained in a range of the luminance value Y=105 to 156.

Thus, a problematic pixel, i.e., the pixel having a pixel value significantly different from that of the target pixel is not contained in these bins.

The image processing device according to an embodiment of the present disclosure performs a bin selection process from the histogram.

It is possible to implement a process equivalent to the process of selecting only the pixel having a pixel value similar to that of the pixel in which the difference with the target pixel is less than 2σ with respect to each of the 35 reference pixels shown in FIG. 4(a). This is achieved only by referring to the bin which contains a target pixel and four neighboring bins, two each at the front and rear thereof, without performing the problematic pixel determination process using a threshold, which described above with reference to FIG. 1.

A corrected pixel value, i.e., a noise-reduced pixel value of a target pixel is determined by using pixel value information of the pixel contained in these selected bins. These processes will be described in detail later.

### 2. EXEMPLARY CONFIGURATION OF IMAGE PROCESSING DEVICE ACCORDING TO EMBODIMENT OF PRESENT DISCLOSURE

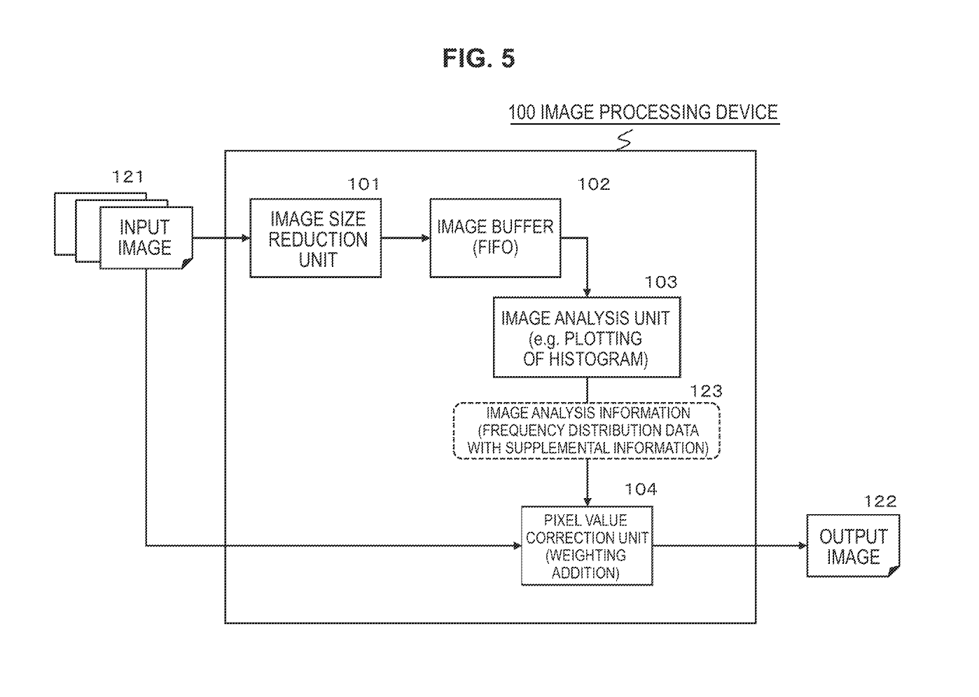

Next, an exemplary configuration of an image processing device according to an embodiment of the present disclosure will now be described with reference to FIG. 5.

FIG. 5 illustrates an exemplary configuration of an image processing device 100 according to an embodiment of the present disclosure.

As shown in FIG. 5, the image processing device 100 includes an image size reduction unit 101, an image buffer (FIFO) 102, an image analysis unit 103, and a pixel value correction unit 104.

An input image 121 is inputted to the image processing device 100. The image processing device 100 performs a pixel value correction process as a noise reduction process on the input image, and generates and outputs an output image 122.

In addition, FIG. 5 is intended to explain processes to be performed by the image processing device according to an embodiment of the present disclosure, and thus illustrates each of the processes in a unit of block. However, a process performed in each block can be executed, for example, by using a program (software). Thus, the image processing device according to the embodiment of the present disclosure can be implemented as a hardware configuration including a CPU and a memory. The CPU functions as a program execution unit, and the memory stores programs executed by the CPU and can be used as an image storage area or work area.

Specifically, it is possible to cause an image pickup device for capturing still or moving images, for example a DSP (digital signaling processor) to execute the process according to the configuration shown in FIG. 5.

In the image processing device 100 shown in FIG. 5, the input image 121 inputted as subjected to the noise reduction (NR) process may be either still or moving images.

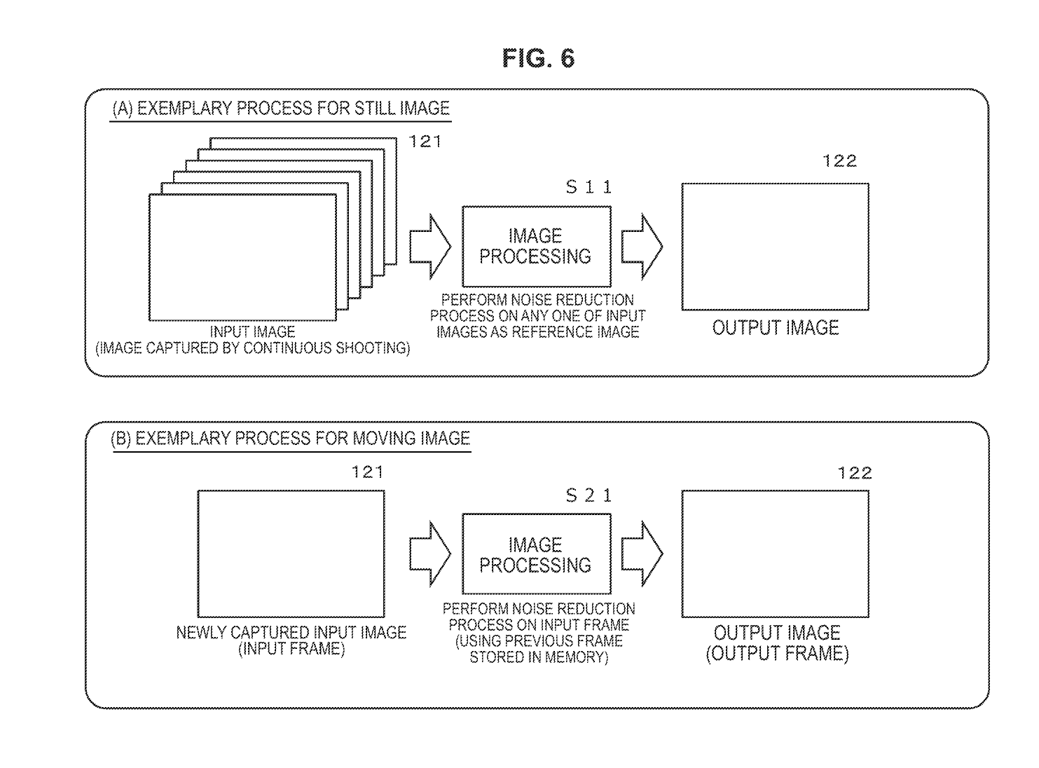

FIG. 6 illustrates examples of the process for each input image as follows.

(A) Example of a noise reduction process for still images

(B) Example of a noise reduction process for moving images

In the case (A) where the noise reduction process is performed for still images, a plurality of still images captured by continuous shooting are inputted, one still image from among the still images is set to be a reference image to be corrected, and the noise reduction process is performed on each pixel contained in the reference image. In the noise reduction process, regions around a pixel (target pixel) to be subjected to the noise reduction process in the reference image and further pixel regions corresponding to the plurality of images captured by continuous shooting are set to be a reference region. Subsequently, a process of correcting a pixel value of a pixel (target pixel) to be subjected to the noise reduction process is performed by using a pixel value of a pixel contained in the reference region.

In addition, in the case (B) where the noise reduction process is performed for moving images, each frame of a moving image is inputted, and the noise reduction process is performed on each pixel in the frame image. In the noise reduction process, regions around a pixel (target pixel) to be subjected to the noise reduction process and pixel regions corresponding to a plurality of previously captured frame image are set to be a reference region. Subsequently, a process of correcting a pixel value of a pixel (target pixel) to be subjected to the noise reduction process is performed by using a pixel value of a pixel contained in the reference region.

### 3. DETAILED DESCRIPTION OF NOISE REDUCTION PROCESS PERFORMED BY IMAGE PROCESSING DEVICE ACCORDING TO EMBODIMENT OF PRESENT DISCLOSURE

A process performed by each component of the image processing device 100 shown in FIG. 5 will now be described.

[3-1. Process Performed by Image Size Reduction Unit]

The configuration of the image size reduction unit 101 in the image processing device 100 shown in FIG. 5 and the process thereof will now be described in detail.

In addition, the image processing device 100 shown in FIG. 5 is configured to reduce the size of an input image, for example, an image captured by a camera, and then perform the noise reduction process on pixels constituting the reduced-size image.

This is intended to improve the processing efficiency and reduce the storage space of image. The input image may be inputted to the image buffer 102 and then may be processed in the image analysis unit 103 without the generation of a reduced-size image, i.e. the size reduction of the input image 121 shown in FIG. 5.

As an exemplary process performed by the image processing device according to an embodiment of the present disclosure, an embodiment of performing a process by reducing the size of input image 121 will now be described.

The image size reduction unit 101 shown in FIG. 5 performs a process of reducing the size of the input image 121, for example a process of setting a 8×8 pixel region of pixels contained in one input image as one pixel, thereby generating a reduced-size image and storing it in the image buffer 102. The reduced-size image is an image in which the number of pixels is reduced. These processes are to be performed whenever an image is inputted.

In other words, these processes are performed for still images captured by continuous shooting or each frame image of moving images.

The reduced-size image generated by the image size reduction unit 101 is stored in the image buffer (FIFO) 102. The image buffer (FIFO) 102 is a FIFO buffer and stores the reduced-size images corresponding to the images captured by continuous shooting in a time series format.

As long as the image size reduction unit 101 is configured to generate a reduced-size image in which the number of pixels of an input image is reduced, a specific configuration thereof is not particularly limited and a variety of configurations can be used.

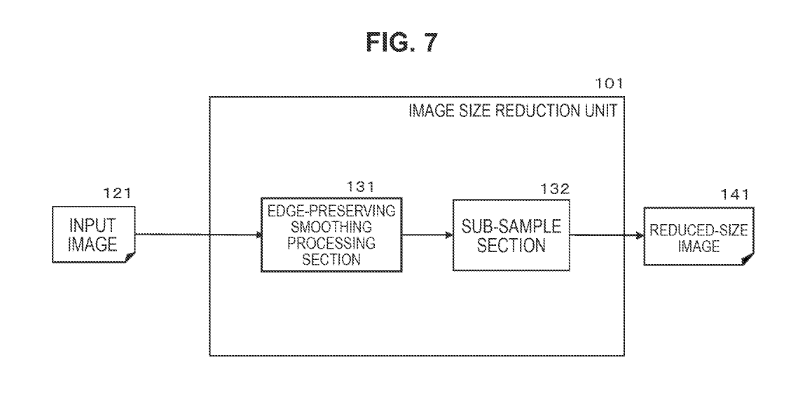

FIG. 7 illustrates an exemplary configuration of the image size reduction unit 101.

The image size reduction unit 101 shown in FIG. 7 includes an edge-preserving smoothing processing section 131 and a sub-sample section 132.

The edge-preserving smoothing processing section 131 of the image size reduction unit 101 shown in FIG. 7 performs an edge-preserving smoothing processing. Specifically, the edge-preserving smoothing processing section 131 performs a strong smoothing processing on a flat portion (a portion in which a change in a pixel value is small) of an input image and performs a weak smoothing processing on an edge portion (a portion in which a change in a pixel value is large).

The sub-sample section 132 receives the smoothed image data from the edge-preserving smoothing processing section 131, performs a pixel value setting process on each pixel in the reduced-size image, and then generates a reduced-size image 141 for output.

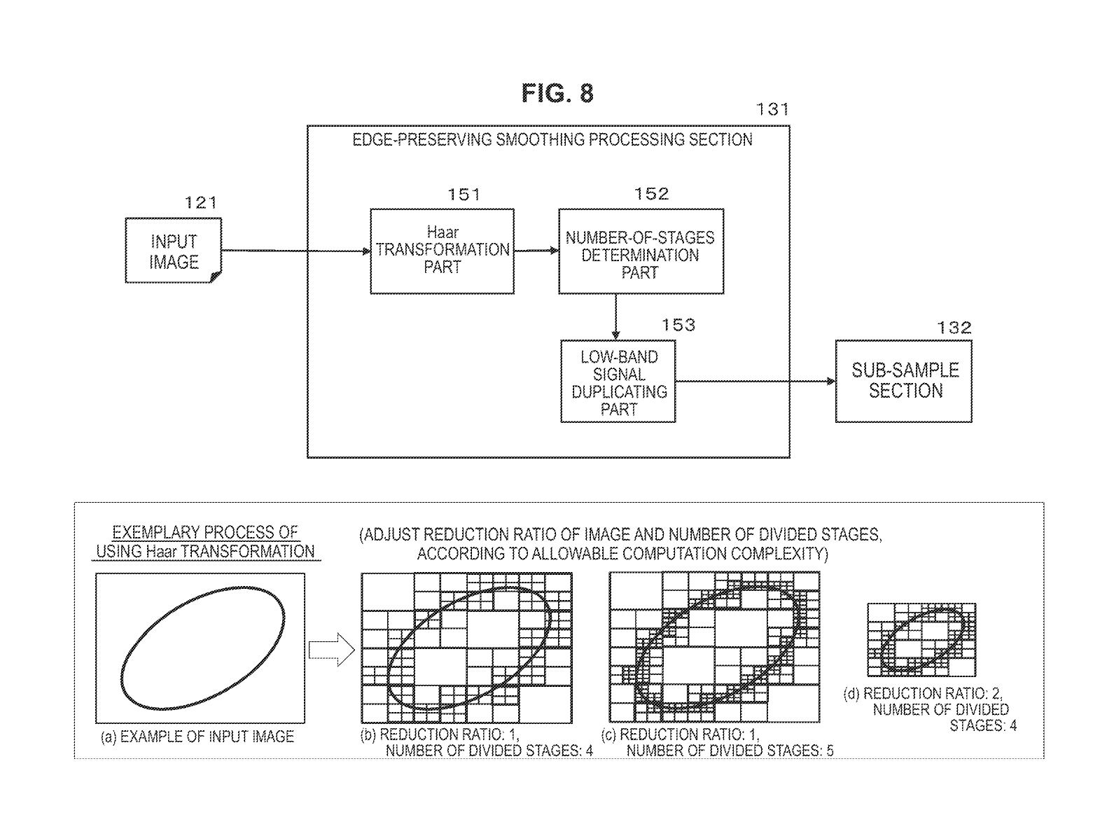

A specific configuration of the edge-preserving smoothing processing section 131 and an exemplary process performed by the edge-preserving smoothing processing section 131 will be described with reference to FIG. 8.

As shown in FIG. 8, the edge-preserving smoothing processing section 131 includes a Haar transformation part 151, a number-of-stages determination part 152, and a low-band duplicating part 153.

The Haar transformation part 151 performs a Haar transformation on the input image 121, and performs a region division which divides the input image into a low-band portion and a high-band portion. Further, the number-of-stages determination part 152 determines the number of performing times of a recursive splitting process from the sum of high-band coefficients.

The low-band duplicating part 153 used as a low-band signal duplicating means performs a process of filling an image with the low-band signal according to the number of stages determined for each region.

The lower portion of FIG. 8 illustrates each exemplary process of using Haar transformation for each case as follows.

(a) Input image

(b) Reduction ratio: 1, Number of stages to be divided: 4

(c) Reduction ratio: 1, Number of stages to be divided: 5

(d) Reduction ratio: 2, Number of stages to be divided: 4

An oval shaped object is drawn in the (a) input image of FIG. 8. A line segment region of this oval shaped object corresponds to the edge region, and other regions correspond to the flat region.

The Haar transformation part 151 discriminates between the edge region and the flat region. The number-of-stages determination part 152 decides the number of stages to be divided. The number of stages is divided finely as the edge region. The (b) and (d) shown in the lower portion of FIG. 8 illustrate a case where the number of stages is 4, and the (c) illustrates a case where the number of stages is 5.

Pixels contained in subdivided rectangular regions shown (b) to (d) of FIG. 8 is set to have the same pixel value. The low-band duplicating part 153 performs a process of setting the pixel value.

The sub-sample section 132 sets a pixel value of each pixel to be contained in a reduced-size image, and generates the reduced-size image 141 in accordance with a pixel configuration according to the reduction ratio based on results obtained from the processes described above. Then, the sub-sample section 132 stores the generated reduced-size image in the image buffer (FIFO) 102.

The configuration of the image size reduction unit 101 described above with reference to FIGS. 7 and 8 is merely illustrative, and the image size reduction unit 101 is not limited to the illustrative configuration. The teachings herein can be applicable to any configuration for generating a reduced-size image in which the number of pixels is reduced.

As shown in FIG. 5, the reduced-size image generated by the image size reduction unit 101 is sequentially stored in the image buffer (FIFO) 102.

[3-2. Process Performed by Image Analysis Unit]

Next, the configuration of the image analysis unit 103 in the image processing device 100 shown in FIG. 5 and the process thereof will now be described in detail.

The image analysis unit 103 performs an image analysis process by using the reduced-size image which is generated by the image size reduction unit 101 and stored in the image buffer 102.

Specifically, the image analysis unit 103 generates frequency distribution data with supplemental information.

A histogram to be used include frequency distribution data of a pixel value (for example, luminance value Y) of each pixel contained in the reference region described above with reference to FIGS. 3 and 4, and the bin width having irregular intervals.

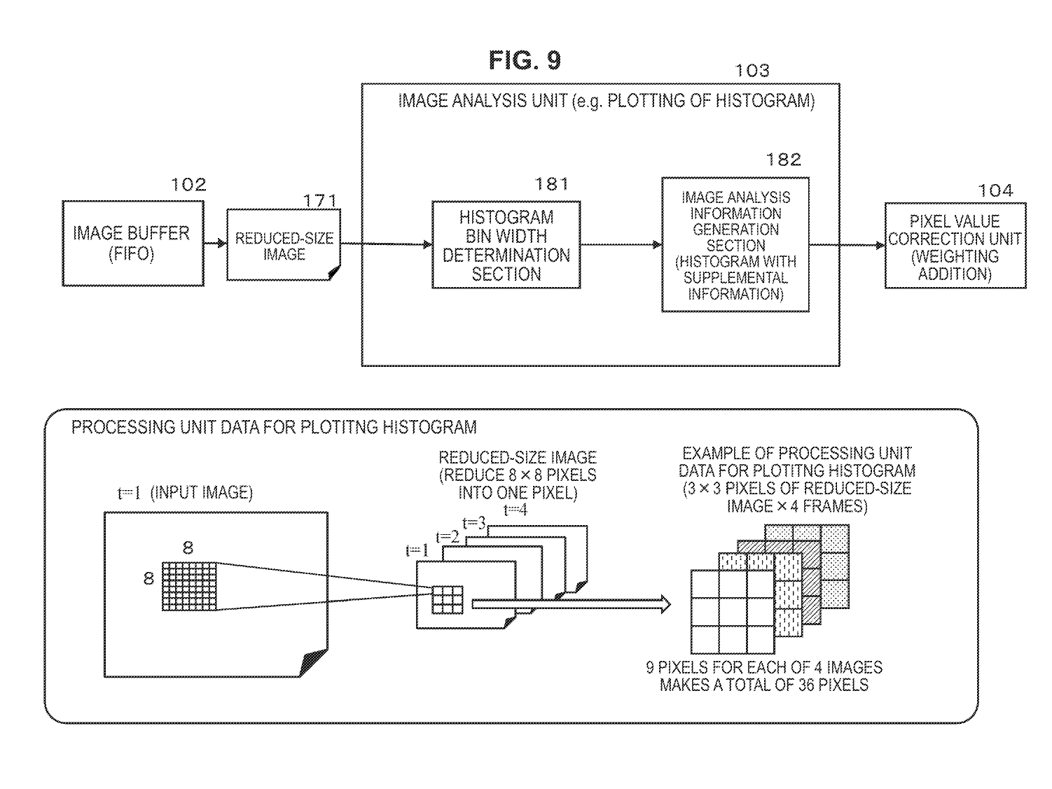

FIG. 9 illustrates an exemplary configuration of the image analysis unit 103.

As shown in FIG. 9, the image analysis unit 103 includes a histogram bin width determination section 181 and an image analysis information generation section 182.

The histogram bin width determination section 181 performs a process of setting a bin width of each bin in a histogram described above with reference to FIGS. 3 and 4, i.e. a pixel value range corresponding to each bin.

The image analysis information generation section 182 plots a histogram with a bin width determined by the histogram bin width determination section 181, and calculates an average value, for example Y, U, and V respectively, of each pixel value of a pixel group corresponding to each bin as pixel value information corresponding to each bin.

Moreover, in the embodiment described below, it is assumed that YUV, i.e. luminance information Y and chrominance information U, V are set to each pixel contained in an input image and a reduced-size image generated from the input image as a pixel value.

A process of applying a luminance value (Y) of each pixel is performed to plot a histogram.

In addition, if the input image is, for example an image to which a pixel value of RGB is set in place of YUV, the process may be performed based on the RGB value. For example, a process having an effect similar to YUV can be performed by performing a pixel value transformation process of calculating a luminance value Y from a RGB value.

In a case where the luminance value (Y) is calculated from a RGB value, the luminance value (Y) can be calculated by using the following transformation equation.

Y=R+2G+B

The lower portion of FIG. 9 illustrates an example of data for a plotting unit of a histogram.

In this case, as an example, the number of pixels to be processed once in plotting of the histogram is a total of 3×3×4=36 pixels constituting a reference region of 3×3 pixels set in each of four reduced-size images in which 8×8 pixels of an input image is set as one pixel.

The histogram is sequentially plotted for each target pixel of the reduced-size image. The target pixel may be a central pixel in the reference region of 3×3 pixels contained in the reduced-size image captured at the time t=1.

The 3×3 pixels having the same coordinate position is selected as a reference region from four reduced-size images captured at the times t=1 to 4, and the 3×3×4=36 pixels is regarded as a plotting unit of the histogram.

The image analysis unit 103 selects a target pixel one by one from among pixels constituting the reduced-size image, sets a reference region corresponding to each target pixel, and plots a histogram corresponding to the target pixel based on the pixel contained in the set reference region.

In other words, the image analysis unit 103 generates the frequency distribution data with supplemental information as image analysis information for each pixel constituting the reduced-size image in a sequential manner. Then, the image analysis unit 103 outputs the data to the pixel value correction unit 104 in the image processing device 100 shown in FIG. 5.

The pixel value correction unit 104 of the image processing device 100 shown in FIG. 5 uses image analysis information for each pixel of the reduced-size image, and thus performs a pixel value correction on pixels in an input image before size reduction corresponding to one pixel of the reduced-size image. That is, the pixel value correction may be performed on 8×8 pixels.

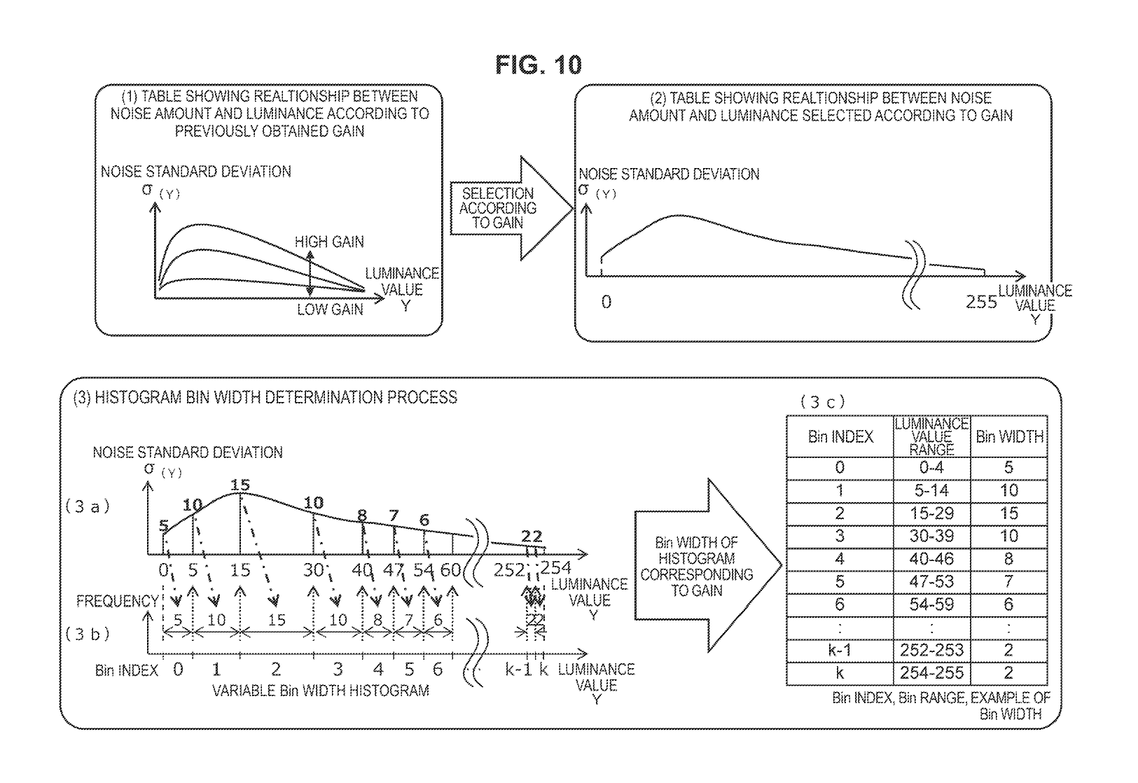

The process performed by the histogram bin width determination section 181 of the image analysis unit 103 shown in FIG. 9 will be described in detail with reference to FIG. 10.

The histogram bin width determination section 181 performs a process of setting a bin width of each bin to be set in the histogram described above with reference to FIGS. 3 and 4, i.e. a pixel value range corresponding to each bin.

The histogram bin width determination section 181 selects data which correlates the amount of noise with the luminance according to gain information at the time of capturing an image from a table showing a corresponding relationship between the amount of noise and the luminance. The table is made according to the gain shown in FIG. 10(1) previously stored in a memory of the image processing device.

The table showing a corresponding relationship between the amount of noise and the luminance shown in FIG. 10(1) is a table similar to that described above with reference to FIG. 3(c).

Specifically, the horizontal axis represents the luminance value (Y), and the vertical axis represents the noise standard deviation σ(y).

There is a general tendency that a small amount of noise is contained in the pixel having a high luminance value but a large amount of noise is contained in the pixel having a low luminance value. Thus, it is known that the corresponding relationship between the luminance value (Y) and the noise standard deviation σ(y) is set as the graph shown in FIG. 10(1).

However, there is a tendency that the amount of noise is large as the gain is high at the time of capturing an image. The memory of the image processing device stores a various types of data indicating a corresponding relationship between the amount of noise and the luminance according to the gain. The histogram bin width determination section 181 selects one piece of data indicating a corresponding relationship between the amount of noise and the luminance according to gain information at the time of capturing an image.

Data shown in FIG. 10(2) is the selected data indicating the corresponding relationship between the amount of noise and the luminance

The histogram bin width determination section 181 determines a bin width of each bin in the histogram by using data indicating the corresponding relationship between the amount of noise and the luminance shown in FIG. 10(2).

The histogram is plotted based on the luminance value (Y) of a total of 36 pixels, i.e. 3×3 pixels which is set in each of the four reduced-size images shown the lower portion of FIG. 9 as described above.

However, as described above referring to FIG. 3 and FIG. 4, the bin width of each bin to be set in the histogram is irregular and is set to be varied in accordance with the noise amount estimated according to the luminance value (Y).

FIG. 10(3) is a diagram for explaining a specific example of a bin width determination process performed by the histogram bin width determination section 181.

FIG. 10(3a) illustrates data indicating a corresponding relationship between the amount of noise and the luminance selected according to the gain as shown in FIG. 10(2).

The horizontal axis represents the luminance value Y (from 0 to 255), and the vertical axis represents the noise standard deviation σ_{(Y)}.

For example, the corresponding relationship between the luminance Y and the noise standard deviation σ_{(Y)} is as follows:

Luminance Y=0→Noise standard deviation σ_{(Y)}=5,

Luminance Y=5→Noise standard deviation σ_{(Y)}=10,

Luminance Y=15→Noise standard deviation σ_{(Y)}=15,

Luminance Y=30→Noise standard deviation σ_{(Y)}=10,

Luminance Y=40→Noise standard deviation σ_{(Y)}=8,

Luminance Y=47→Noise standard deviation σ_{(Y)}=7,

Luminance Y=54→Noise standard deviation σ_{(Y)}=6,

. . .

Luminance Y=252→Noise standard deviation σ_{(Y)}=2, and

Luminance Y=254→Noise standard deviation σ_{(Y)}=2.

In this case, the bin width of the histogram is set as follows. In addition, each bin from the low luminance to the high luminance is assigned a bin index value of 0, 1, 2, 3, and so on.

A bin width of bin 0 is set as follows.

The bin width (luminance width) is set to 5 according to the noise standard deviation σ_{(Y)}=5 corresponding to the luminance value Y=0.

The bin 0 is a bin having a bin width=5, specifically the bin 0 is a bin corresponding to the pixel value (luminance value) of the luminance values Y=0 to 4.

A bin width of bin1 is set as follows.

The bin width (luminance width) is set to 10 according to the noise standard deviation σ_{(Y)}=10 corresponding to the luminance value Y=5.

The bin 1 is a bin having a bin width=10, specifically the bin 1 is a bin corresponding to the pixel value (luminance value) of the luminance values Y=5 to 14.

A bin width of bin 2 is set as follows.

The bin width (luminance width) is set to 15 according to the noise standard deviation σ_{(Y)}=15 corresponding to the luminance value Y=15.

The bin 2 is a bin having a bin width=15, specifically the bin 2 is a bin corresponding to the pixel value (luminance value) of the luminance values Y=15 to 29.

A bin width of bin 3 is set as follows.

The bin width (luminance width) is set to 10 according to the noise standard deviation σ_{(Y)}=10 corresponding to the luminance value Y=30.

The bin 3 is a bin having a bin width=10, specifically the bin 3 is a bin corresponding to the pixel value (luminance value) of the luminance values Y=30 to 39.

Similarly, a value of noise standard deviation σ_{(Y)} corresponding to a luminance value Y is obtained, and the obtained value of noise standard deviation σ_{(Y)} is set as a bin width corresponding to the luminance value Y. The bin width determination process is terminated when the maximum luminance, for example Y=255 is reached.

Furthermore, in the description above, the value of noise standard deviation σ_{(Y)} corresponding to the luminance value Y is applied to a bin width without any change. In other words, the bin width is set as follows.

Bin width=σ_{(Y)}

However, the bin width may be determined by using a multiplication parameter (multiplication factor) k as an adjustable parameter, as follows.

Bin width=k·σ_{(Y)}

The parameter k may be a predetermined fixed value, but may be a parameter configurable by a user.

FIG. 10(3c) illustrates an example of data indicating a bin width determined in this way.

As shown in FIG. 10(3c), the luminance value range and bin width of each bin corresponding to a bin index of 0, 1, 2 and so on are determined. Specifically, the histogram bin width determination section 181 generates bin width determination data, as follows:

Bin 0, Y=0 to 4, Bin width=5,

Bin 1, Y=5 to 14, Bin width=10,

Bin 2, Y=15 to 29, Bin width=15,

Bin 3, Y=30 to 39, Bin width=10,

Bin 4, Y=40 to 46, Bin width=8,

Bin 5, Y=47 to 53, Bin width=7,

Bin 6, Y=54 to 59, Bin width=6,

. . .

Bin k−1, Y=252 to 253, Bin width=2, and

Bin k, Y=254 to 255, Bin width=2.

In this way, the histogram bin width determination section 181 sets a bin width (width of pixel value (luminance value)) varied in accordance with the amount of noise estimated according to the luminance with respect to each of the set bin of the histogram which is a frequency distribution of a pixel value (luminance value) of each pixel in the reference region.

Next, the image analysis information generation section 182 of the image analysis unit 103 shown in FIG. 9 receives bin width information determined by the histogram bin width determination section 181 and plots a histogram. Further, the image analysis information generation section 182 generates supplemental information including pixel value information for each bin in the histogram. In other words, the image analysis information generation section 182 generates frequency distribution data with supplemental information.

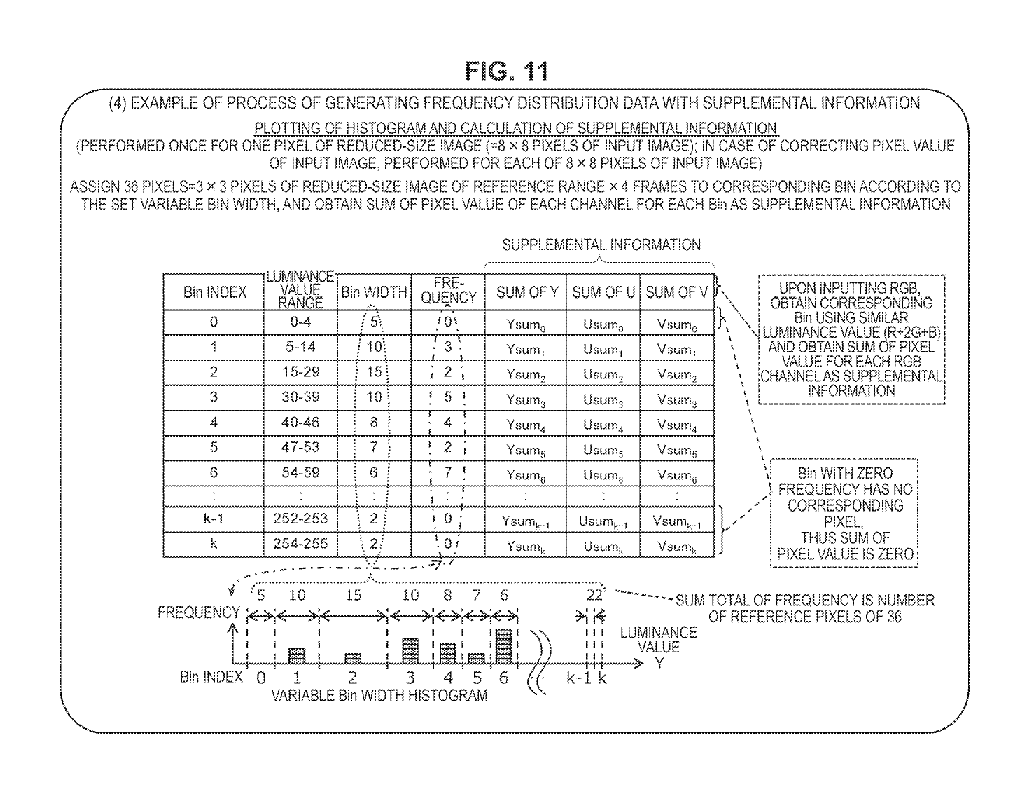

A specific process described above will be described with reference to FIG. 11.

FIG. 11 shows image analysis information generated by the image analysis information generation section 182, i.e. frequency distribution data with supplemental information.

The frequency distribution data with supplemental information contains frequency distribution data of a pixel value of each pixel contained in a reference region as fundamental information. The reference region includes a reference region which is centered on a pixel (target pixel) to be subjected to a noise reduction process from among a reference image selected as an image to be corrected and a reference region in images captured by continuous shooting of the reference image (having the same coordinate position as the reference region of the reference image).

This is generated by using processing unit data for plotting a histogram described with reference to FIG. 9.

The table of FIG. 11 shows frequency distribution data with supplemental information. The table shows data from left column to right column as follows.

(a) Bin index

(b) Luminance value range

(c) Bin width

(d) Frequency

(e) Sum of Y

(f) Sum of U

(g) Sum of V

The data an example of image analysis information generated by the image analysis information generation section 182, i.e. frequency distribution data with supplemental information.

The bin index is an index of each bin in the histogram, i.e. an identification number.

The luminance value range indicates the luminance value range of each bin.

For example, bin 0 is a bin corresponding to the pixel with a luminance value Y of 0 to 4 among pixels contained in the reference region.

The bin width is a bin width of each bin and corresponds to a setting range of the luminance value.

For example, bin 0 is a bin corresponding to the pixel with a luminance value Y of 0 to 4 among pixels contained in the reference region, and has the luminance of 0 to 4, i.e. the setting range of 5. This setting range becomes the bin width.

The frequency indicates the number of pixels of reference pixels corresponding to each bin. The frequency is fundamental data of the histogram.

For example, bin 0 is a bin corresponding to a pixel with the luminance value Y of 0 to 4 among pixels contained in a reference region. In this example, referring to data of FIG. 11, it is found that frequency=0, i.e. there is no pixel corresponding to the luminance range of bin 0 in the reference range.

For example, bin 1 is a bin corresponding to a pixel with the luminance value Y of 5 to 14 among pixels contained in a reference region. In this example, referring to data of FIG. 11, it is found that frequency=3, i.e. there are three pixels corresponding to the luminance range of bin 1 in the reference range.

In addition, the table of FIG. 11 further indicates an exemplary corresponding relationship between the bin width and frequency distribution data and the histogram showing graphically.

Each of the sum of Y, sum of U, and sum of V is a sum total of each pixel value (Y, U, V) of pixels contained in each bin.

For example, bin 1 (luminance value Y=5 to 14) contains three pixels.

These three pixels are regarded as pixel a, pixel b, and pixel c, respectively. Pixel values of these three pixels are regarded as follows.

Pixel a=(Ya,Ua,Va)

Pixel b=(Yb,Ub,Vb)

Pixel c=(Yc,Uc,Vc)

In this case, the sum of Y, sum of U, and sum of V of bin 1 are calculated as follows.

Sum of Y=Ysum1=Ya+Yb+Yc

Sum of U=Usum1=Ua+Ub+Uc

Sum of V=Vsum1=Va+Vb+Vc

In this way, the sum of Y, sum of U, and sum of V are calculated as a sum total of each pixel value (Y, U, V) of pixels contained in each bin.

Thus, the image analysis unit 103 regards results obtained by calculating the frequency information which is fundamental data of the histogram and each value of the sum of Y, sum of U, and sum of V corresponding to the bin as supplemental data of the histogram.

The image analysis unit 103 generates frequency distribution data with supplemental information corresponding to the table shown in FIG. 11 for each target pixel, i.e. in the unit of target pixel be subjected to noise reduction. Then, the image analysis unit 103 outputs the generated frequency distribution data to the pixel value correction unit 104 of the image processing device 100 as shown in FIG. 5.

In addition, as described above, the frequency distribution data with supplemental information is generated for each pixel of the reduced-size pixel.

The pixel value correction unit 104 of the image processing device 100 shown in FIG. 5 uses image analysis information (frequency distribution data with supplemental information) for each pixel of the reduced-size image, and thereby performs a pixel value correction on pixels of an input image, for example 8×8 pixels, before size reduction corresponding to one pixel of the reduced-size image.

[3-3. Process Performed by Pixel Value Correction Unit]

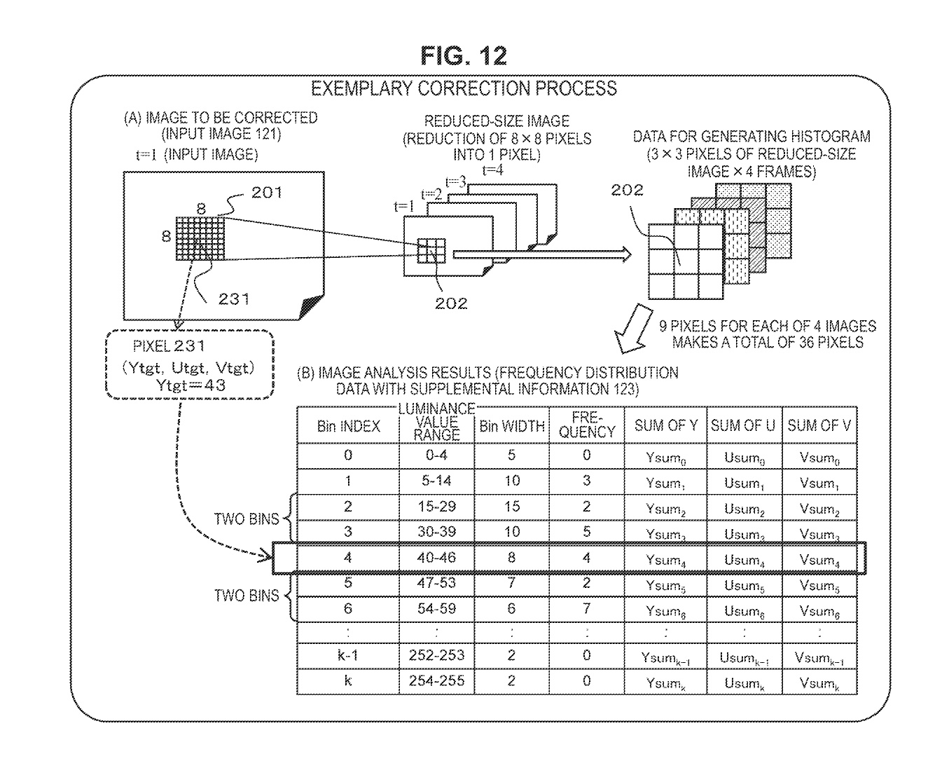

Referring to FIG. 12 and so on, a process performed by the pixel value correction unit 104 of the image processing device 100 shown in FIG. 5 will be described in detail.

As shown in FIG. 5, the pixel value correction unit 104 receives (a) input image 121 and (b) image analysis information (frequency distribution data with supplemental information) 123.

The pixel value correction unit 104 performs a noise reduction process, i.e. a pixel value correction process on pixels constituting input image 121 using the received input information.

In addition, as described above, the image analysis information (frequency distribution data with supplemental information) 123 inputted from the image analysis unit 103 is data for each pixel of the reduced-size image. The pixel value correction unit 104 performs a pixel value correction on pixels in an input image, for example 8×8 pixels, before size reduction corresponding to each pixel of the reduced-size image using the image analysis information (frequency distribution data with supplemental information) for each pixel of the reduced-size image.

FIG. 12 shows data inputted to the pixel value correction unit 104 as follows.

(A) Image to be corrected (input image 121)

(B) Image analysis results (frequency distribution data with supplemental information 123).

The pixel value correction unit 104 receives these data.

However, as described above,

(A) the image to be corrected (input image 121) is an image before reduction, and (B) the image analysis results (frequency distribution data with supplemental information 123) are analysis data corresponding to each pixel of the reduced-size image.

As shown in FIG. 12, for example, a 8×8 pixel region of the input image 121 shown in FIG. 12(A) is set as one pixel 202 of a reduced-size image and 3×3 pixels is set to be centered on the pixel 202 of the reduced-size image (t=1) as a target pixel. Then, the image analysis results (frequency distribution data with supplemental information 123) shown in FIG. 12(B) is generated based on the pixels contained in the reference region set at the same coordinate position of four reduced-size images of the images captured by continuous shooting (t=1 to 4).

The pixel value correction unit 104 performs the pixel value correction on 8×8 pixels 201 of the input image by applying the image analysis results (frequency distribution data with supplemental information 123) shown in FIG. 12(B).

For example, a process in a case where one pixel 231 constituting 8×8 pixels 201 of (A) input image 121 is corrected will be described.

YUV values of the pixel 231 are set as (Ytgt, Utgt, Vtgt).

Specifically, for example, it is regarded as Ytgt=43.

The pixel value correction unit 104 selects a bin which contains a luminance value Y of 43 (luminance value Y=43) of the pixel 231 in the input image from among (B) image analysis results (frequency distribution data with supplemental information 123).

Bin 4 is a bin with the luminance value range of 40 to 46, and the luminance Y of 43 in the pixel 231 corresponds to the bin 4.

In addition, when gain is high, i.e. a high gain is applied to the luminance value Y of the target pixel, there may be a case where it is difficult to select an appropriate corresponding bin. In this case, the smoothing process may be performed by applying a simple low-pass filter, for example, a LPF having three to five taps, using neighboring pixels of the target pixel 231, and the corresponding bin may be selected by applying the smoothed luminance value Y. These processes enable reliable results to be obtained.

Subsequently, the pixel value correction unit 104 selects four neighboring bins, two each at the front and rear of the selected bin 4. As a result, the following five bins are selected.

(1) Bin 2: luminance range=15 to 29, frequency=2,

(2) Bin 3: luminance range=30 to 39, frequency=5,

(3) Bin 4: luminance range=40 to 46, frequency=4,

(4) Bin 5: luminance range=47 to 53, frequency=2, and

(5) Bin 6: luminance range=54 to 59, frequency=7.

The pixel value correction unit 104 selects these five bins.

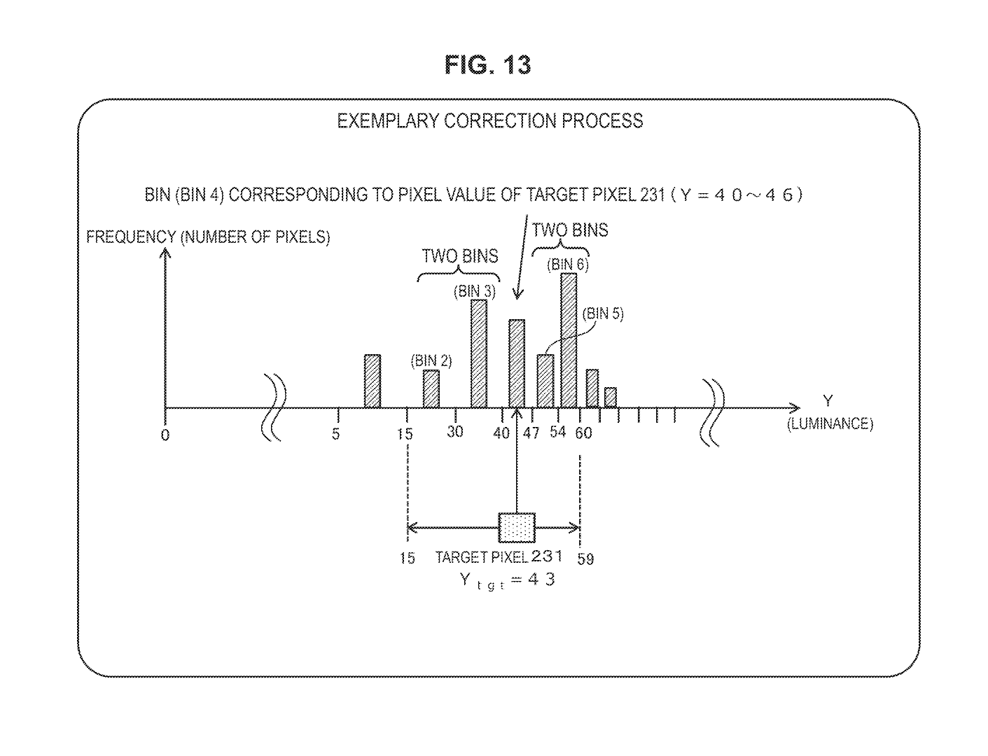

The bin selection process associated with the histogram becomes the setting shown in FIG. 13.

The luminance value Y of the target pixel 231 which is a pixel to be corrected is Y=43, and the corresponding bin is the bin 4.

Four neighboring bins, two each at the front and rear of the bin 4 are selected. In other words, bins 2 and 3 at the front side and bins 5 and 6 at the rear side are selected.

The luminance range of the selected bins 2 to 6 is Y=15 to 59. This luminance range is configured to contain only pixels having approximate values relatively close to the luminance Y=43 of the target pixel 231 which is the pixel to be corrected.

In addition, the number of pixels contained in these bins 2 to 6 is the sum total of the frequencies, i.e. 2+5+4+2+7=20.

This means that 20 pixels are selected and 16 pixels are excluded from among the 36 pixels constituting the histogram.

As an example of the process, a pixel value of the target pixel 231 may be calculated by performing the arithmetic mean operation on pixels of these five selected bins.

In other words, each value of the YUV calculated by performing the arithmetic mean operation on the YUV of 20 pixels constituting the bins 2 to 6 is regarded as the corrected pixel value (YUV) of the target pixel 231.

Thus, such a correction process can be performed.

In addition, a sum total, i.e. summation of each of the YUV of each pixel previously contained in each bin is pre-calculated as the sum of Y(Ysum), sum of U (Usum), and sum of V (Vsum) as shown in the figure. For example, when the arithmetic mean operation is performed on YUV of pixels contained in five bins, it is possible to calculate simply using each summation value (Ysum, Usum, Vsum) and the respective corresponding frequencies.

For example, the arithmetic mean of the luminance value Y of pixels contained in the bins 2 to 6 can be calculated as follows.

Y=(Ysum₂+Ysum₃+Ysum₄+Ysum₅+Ysum₆)/(2+5+4+2+7)

Similarly, it is also possible for U and V to calculate simply using each summation value (Usum, Vsum) and the respective corresponding frequency data.

However, in order to enhance the correction accuracy, it is effective to perform the process of using supplemental information, i.e. each data of sum of U and sum of V from among image analysis results (frequency distribution data with supplemental information 123) shown in FIG. 12(B).

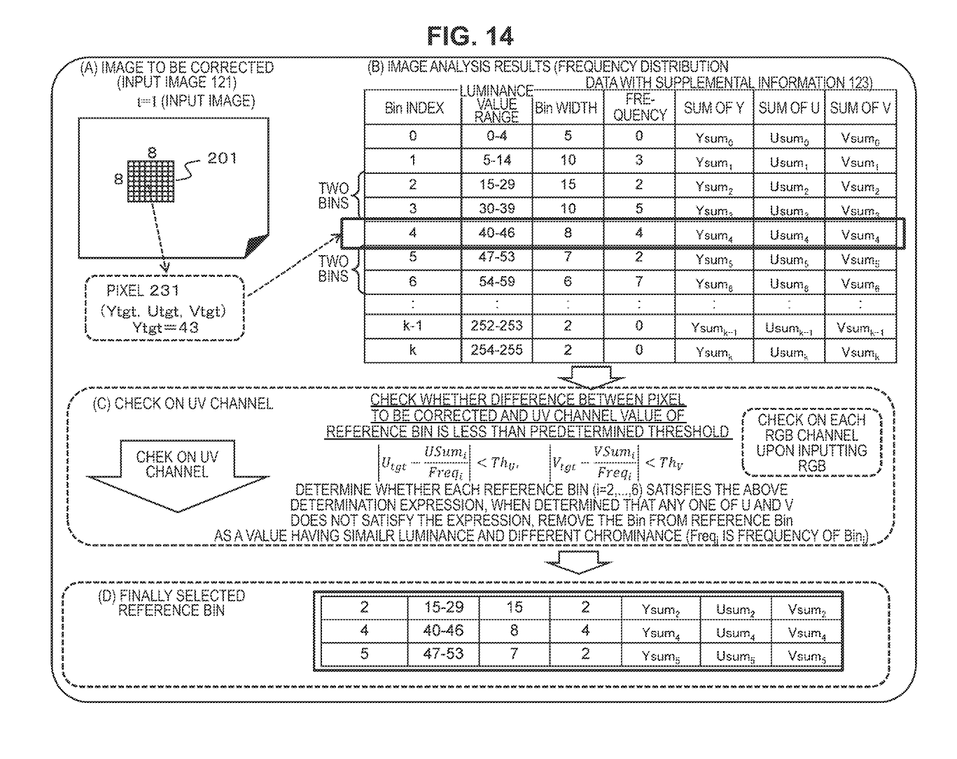

Referring to FIG. 14, an example of a correction process performed by using the supplemental information (sum of U, sum of V) will be described.

As similar to FIG. 12, FIG. 14 shows the following data inputted to the pixel value correction unit 104.

(A) Image to be corrected (input image 121)

(B) Image analysis results (frequency distribution data with supplemental information 123)

The pixel value correction unit 104 selects five bins 2 to 6 applied to the correction of the target pixel 231 which is a pixel to be corrected using the process described above with reference to FIG. 12 and FIG. 13.

The pixel correction unit 104 further performs a bin selection using the supplemental information (sum of U, sum of V) on the five bins.

This process is a process of checking a UV channel shown in FIG. 14(C).

As shown in FIG. 14(C), it is determined whether the differences in values of each UV channel between the pixel (target pixel) to be corrected and the reference bin (bins 2, 3, 4, 5, and 6, in this example) is less than a predetermined threshold. Specifically, the determination is performed according to the following equation (1).

$$\vert {U}_{tgt} - \frac{{USum}_{i}}{{Freq}_{i}} \vert < {Th}_{U} , \vert {V}_{tgt} - \frac{{VSum}_{i}}{{Freq}_{i}} \vert < {Th}_{V} \qquad ( 1 )$$

In the equation (1), the definitions are as follows:

Utgt: value of U of a pixel (target pixel) to be corrected,

Vtgt: value of V of a pixel (target pixel) to be corrected,

Usumi: sum of U of bin i,

Vsumi: sum of V of bin i,

Freqi: frequency of bin i, and

Thu, Thv: predetermined thresholds.

Only a bin satisfying the equation (1) is selected, and bin not satisfying the equation (1) is excluded.

As a result, for example, in a case where bins 2, 4, and 5 satisfy the equation (1) and bins 3 and 6 do not satisfy the equation (1), as shown in FIG. 14(D), only bins 2, 4 and 5 are selected as final reference bins.

Each value of the pixel value (Y, U, V) of the target pixel 231 which is a pixel to be corrected is determined using data contained in these finally selected bins.

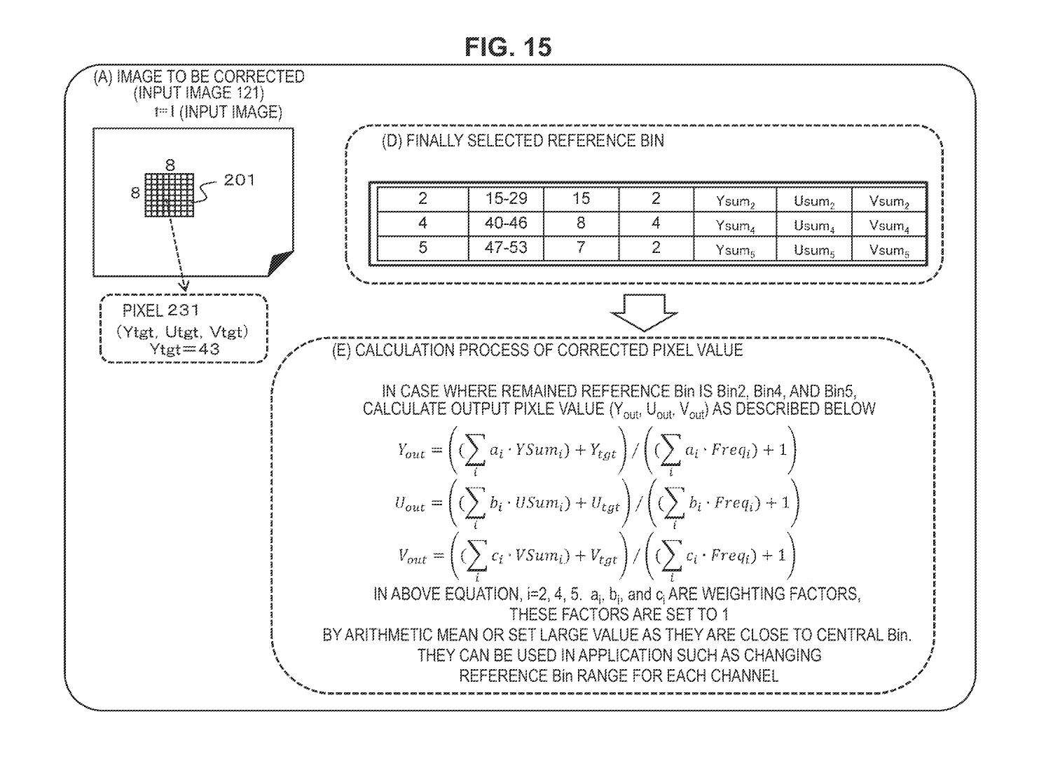

This process will be described with reference to FIG. 15.

FIG. 15(D) shows frequency distribution data with supplemental information of the bins 2, 4 and 5 which are reference bins finally selected by the process described with reference to FIG. 14.

The pixel value correction unit 104 calculates each value of the pixel value (Y, U, V) of the target pixel 231 which is a pixel to be corrected by using the frequency distribution data with supplemental information of the finally selected bin.

Specifically, as shown in FIG. 15(E), the respective corrected pixel values (Yout, Uout, Vout) of the target pixel 231 are calculated by performing the arithmetic mean process according to the following equation (2). The equation (2) is performed by applying YUV=(Ytgt, Utgt, Vtgt) of the target pixel 231 which is a pixel to be corrected, sum of Y (Ysum), sum of U (Usum) and sum of V (Vsum) of the reference bins 2, 4 and 5, and the frequency (Freq) of each bin.

$${Y}_{out} = \frac{( ( {\sum }_{i} {a}_{i} \cdot {YSum}_{i} ) + {Y}_{tgt} )}{( ( {\sum }_{i} {a}_{i} \cdot {Freq}_{i} ) + 1 )} \\ {U}_{out} = \frac{( ( {\sum }_{i} {b}_{i} \cdot {USum}_{i} ) + {U}_{tgt} )}{( ( {\sum }_{i} {b}_{i} \cdot {Freq}_{i} ) + 1 )} \\ {V}_{out} = \frac{( ( {\sum }_{i} {c}_{i} \cdot {VSum}_{i} ) + {V}_{tgt} )}{( ( {\sum }_{i} {c}_{i} \cdot {Freq}_{i} ) + 1 )} \qquad ( 2 )$$

In the equation (2), the definitions are as follows:

Ytgt: value of Y of a pixel (target pixel) to be corrected,

Utgt: value of U of a pixel (target pixel) to be corrected,

Vtgt: value of V of a pixel (target pixel) to be corrected,

Ysumi: sum of U of bin i,

Usumi: sum of U of bin i,

Vsumi: sum of V of bin i, and

Freqi: frequency of bin i.

In the equation (2), ai, bi and ci are weighting factors of bin i. For example, the following condition is established.

ai=bi=ci=1

Alternatively, a large weight may be assigned to a bin corresponding to the target pixel which is a pixel to be corrected and a small weight may be assigned to a bin distant from the bin corresponding to the target pixel.

Further, in this example, since the finally selected bins are 2, 4, and 5, i=2, 4, and 5.

Moreover, in the example of the process described above, there has been described the case where the selection process of the Y, U and V, and reference bins is uniformly performed. However, it may be configured to perform different processes for each channel, such as employing loose or strict selection criteria for each channel.

Furthermore, for example, when a pixel value of the target pixel 231 to be corrected shown in FIG. 12 is sufficiently close to a pixel value of the corresponding pixel of the reduced-size image, i.e. the pixel value of the pixel 202, it can be determined to be a very flat region which is not necessary for noise reduction. In this case, the pixel value of the target pixel may be outputted without any change by skipping the correction process to which the weighted arithmetic mean process is applied. This makes it possible to reduce the computational amount

In addition, there may be a case where the selection of bin described above decreases the number of reference bins or the number of frequencies corresponding to the reference bins, thereby decreasing the number of reference pixels. In such a case, it would not be expected to have a noise reduction effect. Specifically, for example, such a situation occurs when pixels having the luminance similar to that in a reference range due to a moving subject or the like are small in number.

In this case, the process is performed by setting the reference range wider in advance or appropriately. This expansion of the reference range makes it possible to obtain an optimal noise reduction. In addition, specifically, for example the noise reduction process with little deterioration can be performed by increasing the reference range in the time direction rather than in the spatial direction. However, in a case where there is a moving subject or the like, the expansion of the reference range in the spatial direction makes it possible to both obtain the effective noise reduction and minimize the deterioration

### 4. MODIFICATION EXAMPLES OF IMAGE PROCESSING DEVICE ACCORDING TO EMBODIMENT OF PRESENT DISCLOSURE

The configuration of the image processing device 100 shown in FIG. 5 and the process thereof have been described as an exemplary configuration of the image processing device according to the embodiment of the present disclosure.

The exemplary configuration of the image processing device according to the embodiment of the present disclosure is not limited to the configuration shown in FIG. 5, so a variety of configurations are possible. A plurality of modification examples of the image processing device according to the embodiment of the present disclosure will now be described. The description will be made in the following order.

(1) Modification example of performing repeatedly the correction process on the generated corrected image by using a feedback

(2) Modification example of storing histogram in a FIFO buffer and sequentially updating the stored histogram for use

(3) Modification example of tuning a weighting factor and a threshold selected in the reference bin applied to the calculation of a corrected pixel value

These modification examples will be described in that order.

[4-1. Modification Example of Performing Repeatedly the Correction Process on the Generated Corrected Image by Using a Feedback]

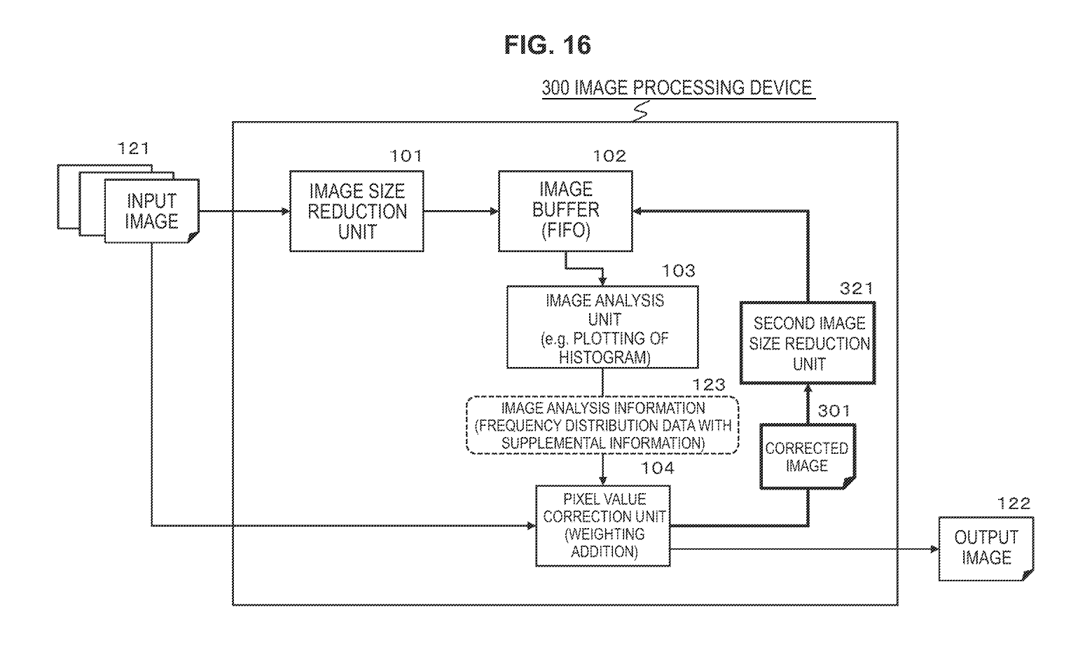

Referring to FIG. 16, a modification example of performing repeatedly the correction process on the corrected image generated by the process according to an embodiment of the present disclosure by using a feedback will be first described.

An image processing device 300 shown in FIG. 16 includes an image size reduction unit 101, an image buffer 102, an image analysis unit 103, and a pixel value correction unit 104, as similar to the image processing device 100 shown in FIG. 5. The image processing device 300 further includes a second image size reduction unit 321.

The second image size reduction unit 321 receives the corrected image 301 generated by the pixel value correction unit 104, and generates a reduced-size image. Then, the second image size reduction unit 321 stores the generated reduced-size image in the image buffer 102.

More specifically, in the image processing device 100 having the configuration described above with reference to FIG. 5, the pixel value correction unit 104 outputs the image having a corrected pixel value as the output image 122. On the other hand, in the image processing device 300 shown in FIG. 16, a corrected image generated by the pixel value correction unit 104 is stored in the image buffer 102, and the pixel value correction unit 104 generates a new corrected image by applying the corrected image previously stored in the image buffer 102. Alternatively, the image processing device 300 may be configured to correct an image having different frame by applying the corrected image as a reference image.

In other words, the pixel value correction unit 104 generates a corrected image 301 based on an input image 121 to be corrected, and further generates an output image 122 by repeatedly performing a process similar to the above-mentioned process on the corrected image 301.

Alternatively, the pixel value correction unit 104 generates the corrected image 301 based on the input image 121 to be corrected, and further generates the output image 122 by setting a reference region to the corrected image 301 and repeatedly performing a process similar to the above-mentioned process when a correction process is performed on the subsequent input image.

The correction process is performed again by applying the previously corrected image, thus it is expected that the correction accuracy will be improved.

[4-2. Modification Example of Storing a Histogram in a FIFO Buffer and Using The Stored Histogram by Updating it Sequentially]

Next, a modification example of storing a histogram in a FIFO buffer and using the stored histogram by updating it sequentially will be described.

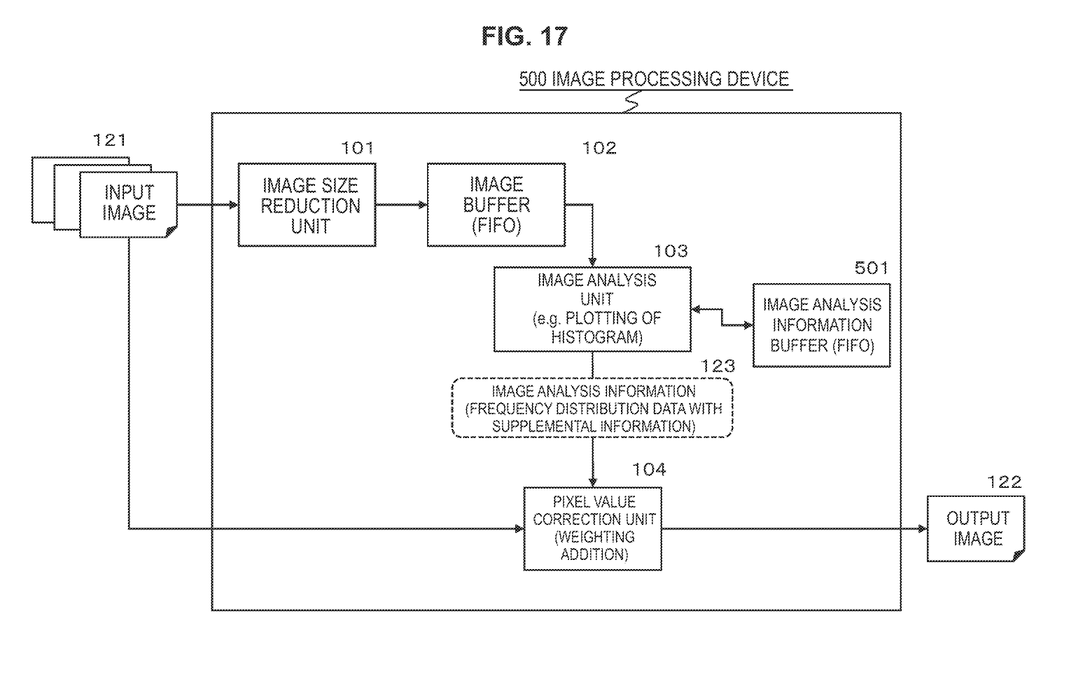

FIG. 17 illustrates an exemplary configuration of an image processing device 500 according to the present modification example.

An image processing device 500 shown in FIG. 17 includes an image size reduction unit 101, an image buffer 102, an image analysis unit 103, and a pixel value correction unit 104, as similar to the image processing device 100 shown in FIG. 5. The image processing device 500 further includes an image analysis information buffer (FIFO) 501.

The image analysis information buffer (FIFO) 501 stores image analysis information generated by the image analysis unit 103.

The image analysis unit 103 generates frequency distribution data with supplemental information shown in FIG. 11 as described in the above embodiment.

As described above, the frequency distribution data with supplemental information shown in FIG. 11 is generated, for example, using processing unit data for plotting a histogram described with reference to FIG. 9.

In other words, the frequency distribution data with supplemental information shown in FIG. 11 is data which is generated based on pixel data of a total of 36 pixels in which the respective sized-reduced images of four images captured by continuous shooting include 3×3=9 pixels.

The image analysis unit 103 shown in FIG. 17 generates frequency distribution data with supplemental information for each reduced-size image and sequentially stores the generated data corresponding to each image in the image analysis information buffer (FIFO) 501.

Specifically, examples of the frequency distribution data with supplemental information for each image are as follows:

(1) Frequency distribution data with supplemental information [D−F(t1)] corresponding to a reduced-size image of an image frame F(t1) captured at the time t=1,

(2) Frequency distribution data with supplemental information [D−F(t2)] corresponding to a reduced-size image of an image frame F(t2) captured at the time t=2,

(3) Frequency distribution data with supplemental information [D−F(t3)] corresponding to a reduced-size image of an image frame F(t3) captured at the time t=3, and

(4) Frequency distribution data with supplemental information [D−F(t4)] corresponding to a reduced-size image of an image frame F(t4) captured at the time t=4.

The frequency distribution data with supplemental information for each image is generated and sequentially stored in the image analysis information buffer (FIFO) 501.

In addition, the image analysis unit 103 generates “frequency distribution data with supplemental information [D−F(tn)]” corresponding to each pixel (x, y) when the pixel (x, y) of each reduced-size image is set as a target pixel, and sequentially stores it in the image analysis buffer (FIFO) 501.

The “frequency distribution data with supplemental information [D−F(tn)]” corresponding to each pixel (x, y) which corresponds to the four images captured by continuous shooting as described above is stored in the image analysis information buffer (FIFO) 501.

The image analysis unit 103 generates the frequency distribution data with supplemental information described above with reference to FIG. 11 by adding four sets of data corresponding to the same pixel position (x, y) from the “frequency distribution data with supplemental information [D−F(tn)]” corresponding to these four images. Then, the image analysis unit 103 outputs the frequency distribution data with supplemental information to the pixel value correction unit 104.

The image analysis information buffer (FIFO) 501 is, for example a FIFO buffer capable of storing the frequency distribution data with supplemental information corresponding to four images. The image analysis information buffer (FIFO) 501 stores data corresponding to images captured at t=1 to 4 and outputs the frequency distribution data with supplemental information to the pixel value correction unit based on the images captured at t=1 to 4. Then, the frequency distribution data with supplemental information corresponding to an image captured at t=1 is replaced by frequency distribution data with supplemental information corresponding to the subsequent image captured at t=5.

In this way, the image analysis information buffer (FIFO) 501 is sequentially updated to store the frequency distribution data with supplemental information corresponding to four latest images.

This configuration allows the image analysis unit 103 to generate and output the frequency distribution data with supplemental information described above with reference to FIG. 11 to the pixel value correction unit 104 by a data addition process using the “frequency distribution data with supplemental information [D−F(tn)]” corresponding to the four images stored in the image analysis information buffer (FIFO) 501.

[4-3. Modification Example of Adjusting (Tuning) a Weighting Factor and a Selected Threshold of Reference Bin Applied to the Calculation of Corrected Pixel Value]

Next, a modification example of adjusting (tuning) a weighting factor and a selected threshold of the reference bin applied to the calculation of a corrected pixel value will be described.

As described above, the pixel value correction unit 104 corrects a pixel value, for example according to the process described above with reference to FIGS. 14 and 15.

Specifically, for example, as shown in FIG. 14, in a case where five bins of bin 2 to bin 6 are selected as a bin applied to the correction of the target pixel 231 which is a pixel to be corrected by the process described above with reference to FIGS. 12 and 13, the bin selection is performed by using supplemental information (sum of U, sum of V) for these five bins.

This process is the process of checking a UV channel shown in FIG. 14(C).

As shown in FIG. 14(C), it is determined whether the difference in each UV channel value between a pixel to be corrected (target pixel) and reference bins (bins 2, 3, 4, 5 and 6, in this example) is less than predetermined thresholds Thu and Thv.

Specifically, the determination is made according to the equation (1) described above, i.e. the following equation (1).

$$\vert {U}_{tgt} - \frac{{USum}_{i}}{{Freq}_{i}} \vert < {Th}_{U} , \vert {V}_{tgt} - \frac{{VSum}_{i}}{{Freq}_{i}} \vert < {Th}_{V} \qquad ( 1 )$$

In the equation (1), the definitions are as follows:

Utgt: value of U of a pixel (target pixel) to be corrected,

Vtgt: value of V of a pixel (target pixel) to be corrected,

Usumi: sum of U of bin i,

Vsumi: sum of V of bin i,

Freqi: frequency of bin i, and

Thu, Thv: predetermined thresholds.

Only a bin satisfying the equation (1) is selected, and bin not satisfying the equation (1) is excluded.

As a result, for example, in a case where bins 2, 4, and 5 satisfy the equation (1) and bins 3 and 6 do not satisfy the equation (1), as shown in FIG. 14(D), bins 2, 4 and 5 are selected as final reference bins.

The respective pixel values (Y, U, V) of the target pixel 231 which is a pixel to be corrected are determined using data contained in these finally selected bins.

This process has been described with reference to FIG. 15.

FIG. 15(D) shows frequency distribution data with supplemental information of the bins 2, 4 and 5 which are reference bins finally selected by the process described with reference to FIG. 14.

The pixel value correction unit 104 calculates the respective pixel values (Y, U, V) of the target pixel 231 which is a pixel to be corrected by using the finally selected frequency distribution data with supplemental information.

Specifically, as shown in FIG. 15(E), the corrected pixel values (Yout, Uout, Vout) of the target pixel 231 are calculated by performing the arithmetic mean process according to the equation (2) described above. The following equation (2) is performed by applying YUV=(Ytgt, Utgt, Vtgt) of the target pixel 231 which is a pixel to be corrected, sum of Y(Ysum), sum of U(Usum) and sum of V(Vsum) of the reference bins 2, 4 and 5, and the frequency (Freq) of each bin.

$${Y}_{out} = \frac{( ( {\sum }_{i} {a}_{i} \cdot {YSum}_{i} ) + {Y}_{tgt} )}{( ( {\sum }_{i} {a}_{i} \cdot {Freq}_{i} ) + 1 )} \\ {U}_{out} = \frac{( ( {\sum }_{i} {b}_{i} \cdot {USum}_{i} ) + {U}_{tgt} )}{( ( {\sum }_{i} {b}_{i} \cdot {Freq}_{i} ) + 1 )} \\ {V}_{out} = \frac{( ( {\sum }_{i} {c}_{i} \cdot {VSum}_{i} ) + {V}_{tgt} )}{( ( {\sum }_{i} {c}_{i} \cdot {Freq}_{i} ) + 1 )} \qquad ( 2 )$$

In the equation (2), the definitions are as follows:

Ytgt: value of Y of a pixel (target pixel) to be corrected,

Utgt: value of U of a pixel (target pixel) to be corrected,

Vtgt: value of V of a pixel (target pixel) to be corrected,

Ysumi: sum of U of bin i,

Usumi: sum of U of bin i,

Vsumi: sum of V of bin i,

Freqi: frequency of bin i, and

ai, bi, ci: weighting factors of bin i.

In this way, in the above-mentioned embodiment, the determination whether the difference in each UV channel value between a pixel to be corrected (target pixel) and reference bins is less than predetermined thresholds Thu and Thy is made by applying the above-mentioned equation (1) when a process of selecting a bin to be set in the reference bin is performed.

In addition, in the calculation of the corrected pixel value, the process to which the equation (2) is applied is performed. The process of using weighting factors ai, bi, and ci corresponding to each bin (i) was performed to calculate a pixel value.

In these processes, the following parameter values may be configured to be appropriately adjusted depending on an image to be corrected or correction conditions.

(a) Thresholds Thu and Thy applied to the bin selection

(b) Weighting factors ai, bi, and ci applied to the calculation of pixel value

Specifically, for example, an adjustment (tuning) as described below is preferably performed.

The arithmetic mean process of a luminance signal is likely to cause texture deterioration. However, noise reduction for minimizing the texture deterioration can be carried out by adjusting the thresholds Thu and Thy applied to the equation (1) or the weighting factors ai, bi, and ci applied to the equation (2).

To achieve this, for example, parameter adjustment is set as follows.

The thresholds Thu and Thy of the equation (1) used to determine a range of reference bin is set loose.

The weighting factors bi and ci applied to the chrominance calculation of the equation (2) to calculate the corrected pixel value are set to be finely multiplied by a wide range of bin, and the weighting factor ai applied to the luminance calculation is set to be coarsely multiplied by a small range of bin.

This parameter adjustment makes it possible to perform the noise reduction for minimizing the texture deterioration.

Further, in a case where color noise is large, when the selection of reference bin is performed according to the equation (1) described above, the following problems may be occurred.

In other words, there may be a large amount of noise in Utgt which is a U value of a pixel to be corrected (target pixel) and Vtgt which is a V value of a pixel to be corrected (target pixel) and the values of Utgt and Vtge are significantly different from a true value. In this case, bins close to a true value may be more likely to be excluded, resulting in decreasing the noise reduction effect.

In order to prevent the occurrence of such problems, for example, the bin selection to which a determination expression as shown in the following equation (3) is applied may be performed.

$$\vert \frac{{USum}_{center}}{{Freq}_{center}} - \frac{{USum}_{i}}{{Freq}_{i}} \vert < {Th}_{U} , \vert \frac{{VSum}_{center}}{{Freq}_{center}} - \frac{{VSum}_{i}}{{Freq}_{i}} \vert < {Th}_{V} \qquad ( 3 )$$

In the equation (3), the definitions are as follows:

Usumcenter: sum of U of a central bin to which a pixel to be corrected (target pixel) belongs,

Vsumcenter: sum of V of a central bin to which a pixel to be corrected (target pixel) belongs,

Freqcenter: frequency of a central bin to which a pixel to be corrected (target pixel) belongs,

Usumi: sum of U of bin i

Vsumi: sum of V of bin i

Freqi: frequency of bin i, and

Thu, Thv: predetermined thresholds.

The above-mentioned equation (3) is an equation to determine a selection range of a reference bin according to the difference in chrominance between a central bin (Center) to which a pixel to be corrected (target pixel) belongs and neighboring bins.

The bin which satisfies the equation (3) is selected as a reference bin.

Even when there may be a large amount of noise in Utgt which is a U value of a pixel to be corrected (target pixel) and Vtgt which is a V value of a pixel to be corrected (target pixel), the possibility that a bin close to a true value is excluded can be reduced by performing the selection of reference bin according to the equation (3), thereby realizing the suitable selection of a reference bin.

However, an erroneous determination may be made in a region a plurality of colors are mixed in a block constituting a plurality of pixels because the limited determination due to chrominance performs in a unit of the block. Thus, it is preferable to determine which one of the equations (1) and (3) is selected according to the amount of noise of a pixel to be corrected.

It is preferable to have a configuration where the equation (1) is applied to the image with a small noise and the equation (3) is applied to the image with a large noise.

In addition, the bin selection process of using any one of the equations (1) and (3) can be performed by the generated histogram, so the histogram may be previously obtained when plotting the histogram.

### 5. EXAMPLE OF HARDWARE CONFIGURATION OF IMAGE PROCESSING DEVICE

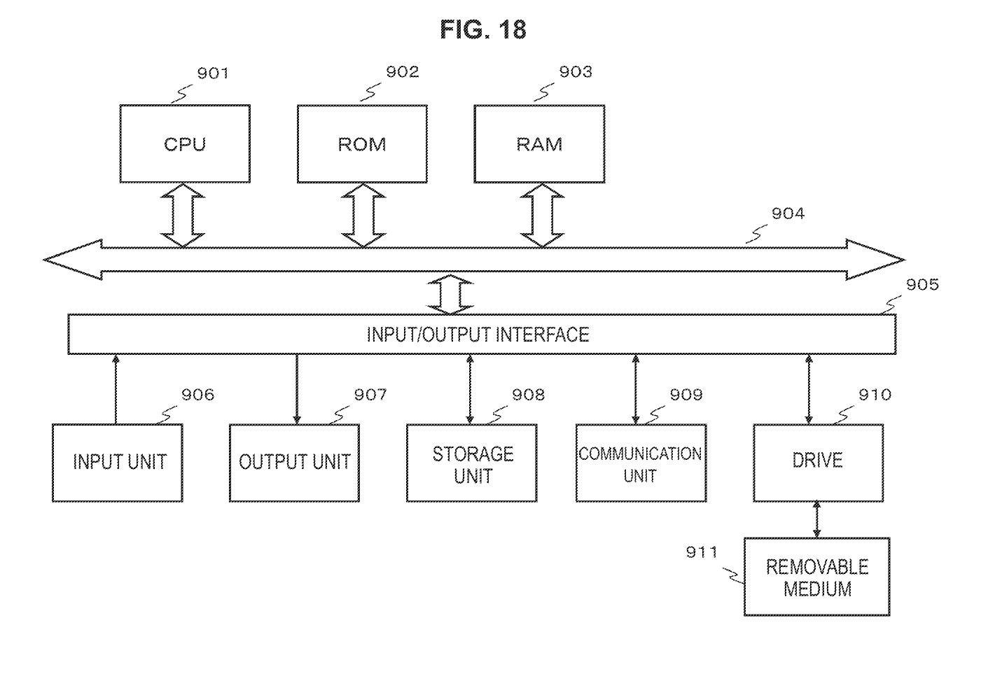

Next, referring to FIG. 18, an example of the hardware configuration of any one of the image processing devices for performing the processes described above will be described. A CPU (Central Processing Unit) 901 executes a variety of processes according to a program stored in a ROM (Read Only Memory) 902 or a storage unit 908. Examples of an image process performed by the CPU 901 include, for example, the reduced-size image generation process, image analysis process, and noise reduction process applying results obtained by the image analysis process, which are described in the above embodiments and examples. Program or data executed by the CPU 901 is appropriately stored in a RAM (Random Access Memory) 903. These components including the CPU 901, ROM 902, and RAM 903 are interconnected via a bus 904.

The CPU 901 is connected to an input/output interface 905 via the bus 904. The input/output interface 905 is connected to an input unit 906 and an output unit 907. The input unit 906 may include a keyboard, a mouse, a microphone, or the like. The output unit 907 may include a display, a speaker, or the like. The CPU 901 executes a various types of process corresponding to instructions inputted from the input unit 906 and outputs results obtained from the process to the output unit 907.

The storage unit 908 connected to the input/output interface 905 may be configured from, for example, a hard disk, and may store programs to be executed by the CPU 901 and a variety types of data. A communication unit 909 communicates with an external device over a network such as the Internet or a local area network.

A drive 910 connected to the input/output interface 905 drives a removable medium 911 such as a magnetic disk, an optical disk, a magneto-optical disk, or a semiconductor memory, and obtains programs or data recorded in the removable medium. The obtained programs and data are transferred and stored to the storage unit 908 as necessary.

### 6. CONCLUSION

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing device including:

an image analysis unit for generating image analysis information having frequency distribution data which corresponds to a pixel value of a pixel contained in a reference region used to select a reference pixel applied to correction of a pixel value of a pixel to be subjected to noise reduction; and

a pixel value correction unit for correcting a pixel value by applying the image analysis information,

wherein the image analysis unit sets a plurality of bins having different bin widths which are set by a luminance range varying in size depending on a luminance value, and generates frequency distribution data obtained by setting the number of pixels contained in a luminance range corresponding to each bin as frequency data, and

wherein the pixel value correction unit selects a bin corresponding to a pixel to be corrected which is a bin including the pixel value of the pixel to be subjected to noise reduction and a predetermined number of neighboring bins of the bin corresponding to the pixel to be corrected, and calculates a corrected pixel value of the pixel to be subjected to noise reduction by an arithmetic operation process to which a pixel value of a reference pixel contained in the selected bin is applied.

(2) The image processing device according to (1), wherein the pixel value correction unit calculates the corrected pixel value of the pixel to be subjected to noise reduction by performing an arithmetic mean process on the pixel value of the reference pixel contained in the selected bin.
(3) The image processing device according to (1) or (2), wherein the image analysis unit generates frequency distribution data obtained by setting a value of noise standard deviation σ(Y) corresponding to a luminance value Y or a value kσ(Y) as the bin width by using data indicating a corresponding relationship between the luminance value and the noise standard deviation, the value kσ(Y) being obtained by multiplying the noise standard deviation σ(Y) by a predetermined factor k.
(4) The image processing device according to any one of (1) to (3), wherein the image analysis unit generates sum data obtained by adding a pixel value of a pixel corresponding to each bin as supplemental data in conjunction with the frequency distribution data which is set by the plurality of bins having different bin widths.
(5) The image processing device according to (4), wherein the image analysis unit generates sum data obtained by adding each of respective pixel values Y, U, and V of a pixel corresponding to each bin as the supplemental data.
(6) The image processing device according to (5), wherein the pixel value correction unit reselects a bin in which a difference between the pixel value of the pixel to be subjected to noise reduction and respective average values of U and V of the selected bin calculated from sum data obtained by adding each of respective pixel values U and V which are the supplemental data of the selected bin is determined to be less than a predetermined threshold, and calculates the corrected pixel value of the pixel to be subjected to noise reduction by performing an arithmetic operation process to which a pixel value of a reference pixel contained in the reselected bin is applied.
(7) The image processing device according to (5), wherein the pixel value correction unit reselects a bin in which a difference between respective average values of U and V of a central bin including the pixel to be subjected to noise reduction and respective average values of U and V of the selected bin is determined to be less than a predetermined threshold, and calculates the corrected pixel value of the pixel to be subjected to noise reduction by performing an arithmetic operation process to which a pixel value of a reference pixel contained in the reselected bin is applied.
(8) The image processing device according to any one of (1) to (7), further including:

an image size reduction unit for reducing a size of an image including the pixel to be subjected to noise reduction,

wherein the image analysis unit generates the image analysis information based on a reduced-size image generated by the image size reduction unit.

(9) The image processing device according to (8), wherein the image size reduction unit generates the reduced-size image by performing an edge-preserving smoothing process.
(10) The image processing device according to any one of (1) to (9), wherein the image analysis unit sets a pixel region corresponding to a plurality of images captured by continuous shooting as a reference region and generates image analysis information having frequency distribution data corresponding to a pixel value of a pixel contained in the reference region, the plurality of images being constituted by an image which contains the pixel to be subjected to noise reduction.
(11) The image processing device according to (10), wherein the image analysis unit generates the frequency distribution data for each image, stores the generated frequency distribution data for each image in a FIFO buffer, and generates image analysis information having frequency distribution data which corresponds to a pixel value of a pixel contained in a reference region set in a plurality of images captured by continuous shooting by performing an arithmetic operation process on the frequency distribution data of the plurality of images stored in the FIFO buffer.

Further, embodiments of the present disclosure also contain a method of performing the process used in the above-mentioned device and system or programs for executing the process.

Moreover, the above-mentioned sequence of processing operations may be executed by software, hardware, or a combination of both. When the above-mentioned sequence of processing operations is executed by software, the programs constituting the software are installed in a computer which is built in dedicated hardware equipment or installed into a general-purpose personal computer for example in which various programs may be installed for the execution of various functions. For example, programs can be recorded to recording media in advance. In addition to the installation of programs from the recording media onto the computer, programs can be downloaded via a network such as LAN (Local Area Network) or the Internet into recording media such as an incorporated hard disk drive or the like.

It should be noted herein that, the steps for describing each, program recorded in recording media include not only the processing operations which are sequentially executed in a time-dependent manner but also the processing operations which are executed concurrently or discretely. It should also be noted that term system as used herein denotes a logical set of a plurality of component units and these component units are not necessarily accommodated in a same housing.

As apparent from the foregoing, according to the embodiments of the present disclosure, there is provided a device and method capable of realizing an effective noise reduction process on an image.

Specifically, a device according to an embodiment of the present disclosure includes an image analysis unit for generating image analysis information having frequency distribution data which corresponds to a pixel value of a pixel contained in a reference region used to select a reference pixel applied to correction of a pixel value of a pixel to be subjected to noise reduction; and a pixel value correction unit for correcting a pixel value by applying the image analysis information. The image analysis unit sets a plurality of bins having different bin widths which are set by a luminance range varying in size depending on a luminance value, and generates frequency distribution data obtained by setting the number of pixels contained in a luminance range corresponding to each bin as frequency data. The pixel value correction unit selects a bin corresponding to a pixel to be corrected which is a bin including the pixel value of the pixel to be subjected to noise reduction and a predetermined number of neighboring bins of the bin corresponding to the pixel to be corrected, and calculates a corrected pixel value of the pixel to be subjected to noise reduction by an arithmetic operation process to which a pixel value of a reference pixel contained in the selected bin is applied.

These processes makes it possible to promptly select only a pixel having a pixel value similar to that of a pixel to be corrected and realize an effective pixel value correction process, without performing a process for determining whether each pixel is a problematic pixel.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-051297 filed in the Japan Patent Office on Mar. 8, 2012 and Japanese Priority Patent Application JP 2012-145055 filed in the Japan Patent Office on Jun. 28, 2012, the entire content of which is hereby incorporated by reference.

What is claimed is:

1. An image processing device comprising:
an image analysis unit for generating image analysis information having frequency distribution data which corresponds to a pixel value of a pixel contained in a reference region used to select a reference pixel applied to correction of a pixel value of a pixel to be subjected to noise reduction; and
a pixel value correction unit for correcting a pixel value by applying the image analysis information,
wherein the image analysis unit sets a plurality of bins having different bin widths which are set by a luminance range varying in size depending on a luminance value, and generates frequency distribution data obtained by setting the number of pixels contained in a luminance range corresponding to each bin as frequency data, and
wherein the pixel value correction unit selects a bin corresponding to a pixel to be corrected which is a bin including the pixel value of the pixel to be subjected to noise reduction and a predetermined number of neighboring bins of the bin corresponding to the pixel to be corrected, and calculates a corrected pixel value of the pixel to be subjected to noise reduction by an arithmetic operation process to which a pixel value of a reference pixel contained in the selected bin is applied.

2. The image processing device according to claim 1, wherein the pixel value correction unit calculates the corrected pixel value of the pixel to be subjected to noise reduction by performing an arithmetic mean process on the pixel value of the reference pixel contained in the selected bin.

3. The image processing device according to claim 1, wherein the image analysis unit generates frequency distribution data obtained by setting a value of noise standard deviation σ(Y) corresponding to a luminance value Y or a value kσ(Y) as the bin width by using data indicating a corresponding relationship between the luminance value and the noise standard deviation, the value kσ(Y) being obtained by multiplying the noise standard deviation σ(Y) by a predetermined factor k.

4. The image processing device according to claim 1, wherein the image analysis unit generates sum data obtained by adding a pixel value of a pixel corresponding to each bin as supplemental data in conjunction with the frequency distribution data which is set by the plurality of bins having different bin widths.

5. The image processing device according to claim 4, wherein the image analysis unit generates sum data obtained by adding each of respective pixel values Y, U, and V of a pixel corresponding to each bin as the supplemental data.

6. The image processing device according to claim 5, wherein the pixel value correction unit reselects a bin in which a difference between the pixel value of the pixel to be subjected to noise reduction and respective average values of U and V of the selected bin calculated from sum data obtained by adding each of respective pixel values U and V which are the supplemental data of the selected bin is determined to be less than a predetermined threshold, and calculates the corrected pixel value of the pixel to be subjected to noise reduction by performing an arithmetic operation process to which a pixel value of a reference pixel contained in the reselected bin is applied.

7. The image processing device according to claim 5, wherein the pixel value correction unit reselects a bin in which a difference between respective average values of U and V of a central bin including the pixel to be subjected to noise reduction and respective average values of U and V of the selected bin is determined to be less than a predetermined threshold, and calculates the corrected pixel value of the pixel to be subjected to noise reduction by performing an arithmetic operation process to which a pixel value of a reference pixel contained in the reselected bin is applied.

8. The image processing device according to claim 1, further comprising:
an image size reduction unit for reducing a size of an image including the pixel to be subjected to noise reduction,
wherein the image analysis unit generates the image analysis information based on a reduced-size image generated by the image size reduction unit.

9. The image processing device according to claim 8, wherein the image size reduction unit generates the reduced-size image by performing an edge-preserving smoothing process.

10. The image processing device according to claim 1, wherein the image analysis unit sets a pixel region corresponding to a plurality of images captured by continuous shooting as a reference region and generates image analysis information having frequency distribution data corresponding to a pixel value of a pixel contained in the reference region, the plurality of images being constituted by an image which contains the pixel to be subjected to noise reduction.

11. The image processing device according to claim 10, wherein the image analysis unit generates the frequency distribution data for each image, stores the generated frequency distribution data for each image in a FIFO buffer, and generates image analysis information having frequency distribution data which corresponds to a pixel value of a pixel contained in a reference region set in a plurality of images captured by continuous shooting by performing an arithmetic operation process on the frequency distribution data of the plurality of images stored in the FIFO buffer.

12. An image processing method of performing a noise reduction process on a pixel in an image processing device, the image processing method comprising:
generating, by an image analysis unit, image analysis information having frequency distribution data which corresponds to a pixel value of a pixel contained in a reference region used to select a reference pixel applied to correction of a pixel value of a pixel to be subjected to noise reduction; and
correcting, by a pixel value correction unit, a pixel value by applying the image analysis information,
wherein the image analysis step is a step of setting a plurality of bins having different bin widths which are set by a luminance range varying in size depending on a luminance value, and generating frequency distribution data obtained by setting the number of pixels contained in a luminance range corresponding to each bin as frequency data, and
wherein the pixel value correction step is a step of selecting a bin corresponding to a pixel to be corrected which is a bin including the pixel value of the pixel to be subjected to noise reduction and a predetermined number of neighboring bins of the bin corresponding to the pixel to be corrected, and calculating a corrected pixel value of the pixel to be subjected to noise reduction by an arithmetic operation process to which a pixel value of a reference pixel contained in the selected bin is applied.

13. A program for causing an image processing device to perform a noise reduction process on a pixel, the process comprising:
generating, by an image analysis unit, image analysis information having frequency distribution data which corresponds to a pixel value of a pixel contained in a reference region used to select a reference pixel applied to correction of a pixel value of a pixel to be subjected to noise reduction; and
correcting, by a pixel value correction unit, a pixel value by applying the image analysis information,
wherein the image analysis step is a step of setting a plurality of bins having different bin widths which are set by a luminance range varying in size depending on a luminance value, and generating frequency distribution data obtained by setting the number of pixels contained in a luminance range corresponding to each bin as frequency data, and
wherein the pixel value correction step is a step of selecting a bin corresponding to a pixel to be corrected which is a bin including the pixel value of the pixel to be subjected to noise reduction and a predetermined number of neighboring bins of the bin corresponding to the pixel to be corrected, and calculating a corrected pixel value of the pixel to be subjected to noise reduction by an arithmetic operation process to which a pixel value of a reference pixel contained in the selected bin is applied.
